(19) United States
(12) Patent Application Publication
(10) Pub. No.: US 2022/0375668 A1
(43) Pub. Date: Nov. 24, 2022

(54) MAGNETIC PARTICLE-CONTAINING COMPOSITION, MAGNETIC PARTICLE-CONTAINING FILM, AND ELECTRONIC COMPONENT

(71) Applicant: FUJIFILM Corporation, Tokyo (JP)

(72) Inventors: Tetsushi MIYATA, Haibara-gun (JP); Tatsuo Ishikawa, Haibara-gun (JP)

(73) Assignee: FUJIFILM Corporation, Tokyo (JP)

(21) Appl. No.: 17/852,845

(22) Filed: Jun. 29, 2022

Related U.S. Application Data
(63) Continuation of application No. PCT/JP2021/000272, filed on Jan. 7, 2021.

(30) Foreign Application Priority Data
Feb. 5, 2020 (JP) 2020-018098

(51) Int. Cl. H01F 1/26; B22F 1/107; B22F 1/05

(52) U.S. Cl. CPC H01F 1/26; B22F 1/107; B22F 1/05; B22F 2304/10

(57) ABSTRACT

A magnetic particle-containing composition contains magnetic particles having a plurality of peak tops in a particle size distribution curve showing a volume-based frequency distribution, a resin, and a solvent.

### CROSS-REFERENCE TO RELATED APPLICATIONS

This application is a Continuation of PCT International Application No. PCT/JP2021/000272 filed on Jan. 7, 2021, which claims priority under 35 U.S.C § 119(a) to Japanese Patent Application No. 2020-018098 filed on Feb. 5, 2020. Each of the above application(s) is hereby expressly incorporated by reference, in its entirety, into the present application.

### BACKGROUND OF THE INVENTION

### 1. Field of the Invention

The present invention relates to a magnetic particle-containing composition, a magnetic particle-containing film, and an electronic component.

### 2. Description of the Related Art

In electronic communication devices and the like, from the viewpoint of noise reduction and energy efficiency improvement, electronic components using magnetic materials are used. In the related art, an inductor obtained by winding a coil around a magnetic composite material is mounted on a printed wiring board, the magnetic composite material being obtained by filling a mold with a composition having soft magnetic metal powder and a resin and curing the composition.

However, due to the recent demand for miniaturization of electronic components, sometimes a method of forming a coil by a conductor pattern of a printed wiring board and providing an inductor on the inside of the printed wiring board is adopted. Regarding the manufacture of an electronic component such as the aforementioned inductor, for example, JP2009-263645A discloses the use of a paste composition (magnetic particle-containing composition) that contains magnetic inorganic particles (magnetic particles), a compound having a function of dispersing the magnetic inorganic particles, a resin, and an organic solvent.

### SUMMARY OF THE INVENTION

With reference to JP2009-263645A, the inventors of the present invention prepared a magnetic particle-containing composition containing magnetic particles, a resin, and a solvent. As a result, the inventors have revealed that sometimes it is difficult to simultaneously achieve excellent sedimentation stability of magnetic particles in the magnetic particle-containing composition (that is, making it difficult for magnetic particle sedimentation to occur) and excellent magnetic permeability of a magnetic particle-containing film obtained using the magnetic particle-containing composition, and that there is a room for improvement.

An object of the present invention is to provide a magnetic particle-containing composition that can form a magnetic particle-containing film having excellent magnetic permeability and is excellent in sedimentation stability. Another object of the present invention is to provide a magnetic particle-containing film that is formed of the magnetic particle-containing composition, and an electronic component that includes the magnetic particle-containing film.

In order to achieve the above objects, the inventors of the present invention conducted intensive studies. As a result, the inventors have found that a magnetic particle-containing composition containing magnetic particles that have a plurality of peak tops in a particle size distribution curve showing a volume-based frequency distribution, a resin, and a solvent is excellent in sedimentation stability, and that a magnetic particle-containing film formed of this composition has excellent magnetic permeability. Based on these findings, the inventors have accomplished the present invention.

That is, the inventors of the present invention have found that the above objects can be achieved by the following constitutions.

[1]

A magnetic particle-containing composition containing magnetic particles having a plurality of peak tops in a particle size distribution curve showing a volume-based frequency distribution, a resin, and a solvent.

[2]

The magnetic particle-containing composition described in [1], in which in a case where Dmin represents a particle diameter at a peak top Pmin where a particle diameter is minimized and Dmax represents a particle diameter at a peak top Pmax where a particle diameter is maximized among the plurality of peak tops in the particle size distribution curve showing a volume-based frequency distribution, a ratio of the Dmax to the Dmin is more than 2.

[3]

The magnetic particle-containing composition described in [1] or [2], in which in a case where Dmin represents a particle diameter at a peak top Pmin where a particle diameter is minimized among the plurality of peak tops in the particle size distribution curve showing a volume-based frequency distribution, the Dmin is equal to or greater than a particle diameter D₂₀ having a frequency of 20% in the particle size distribution curve showing a volume-based cumulative distribution.

[4]

The magnetic particle-containing composition described in [2] or [3], in which the Dmin is 1 to 10 μm.

[5]

The magnetic particle-containing composition described in any one of [1] to [4], in which the magnetic particles have two peak tops.

[6]

The magnetic particle-containing composition described in any one of [1] to [5], in which a content of the magnetic particles is 60% by mass or more with respect to a total mass of the magnetic particle-containing composition.

[7]

The magnetic particle-containing composition described in any one of [1] to [6], in which the resin has an acid group, a basic group, or an amide group.

[8]

The magnetic particle-containing composition described in any one of [1] to [7], in which a solubility of the resin in the solvent is 10 g/L or more.

[9]

A magnetic particle-containing film formed of the magnetic particle-containing composition described in any one of [1] to [8].

[10]

An electronic component including the magnetic particle-containing film described in [9].

[11]

The electronic component described in [10], in which the electronic component is used as an inductor.

[12]

The electronic component described in [10], in which the electronic component is used as an antenna.

According to an aspect of the present invention, it is possible to provide a magnetic particle-containing composition that can form a magnetic particle-containing film having excellent magnetic permeability and is excellent in sedimentation stability. Furthermore, according to an aspect of the present invention, it is possible to provide a magnetic particle-containing film that is formed of the magnetic particle-containing composition and an electronic component that includes the magnetic particle-containing film.

### BRIEF DESCRIPTION OF THE DRAWINGS

FIG. 1 is a particle size distribution graph illustrating an example of a particle size distribution curve showing a volume-based frequency distribution of magnetic particles contained in the composition according to an embodiment of the present invention.

FIG. 2 is a particle size distribution graph illustrating an example of a particle size distribution curve showing a volume-based cumulative distribution of magnetic particles contained in the composition according to an embodiment of the present invention.

### DESCRIPTION OF THE PREFERRED EMBODIMENTS

Hereinafter, the present invention will be specifically described.

The following constituents will be described based on typical embodiments of the present invention in some cases. However, the present invention is not limited to the embodiments.

Regarding the notation of a group (atomic group) in the present specification, unless the gist of the present invention is missed, the notation without the terms “substituted” and “unsubstituted” includes both the group having no substituent and the group having a substituent. For example, “alkyl group” includes not only an alkyl group having no substituent (unsubstituted alkyl group) but also an alkyl group having a substituent (substituted alkyl group). Furthermore, in the present specification, “organic group” refers to a group having at least one carbon atom.

In the present specification, “actinic ray” or “radiation” means, for example, a bright line spectrum of a mercury lamp, a far ultraviolet ray represented by an excimer laser, extreme ultraviolet (EUV light), an X-ray, an electron beam (EB), and the like. In the present specification, “light” means an actinic ray or radiation.

Unless otherwise specified, “exposure” in the present specification means not only the exposure performed using a bright line spectrum of a mercury lamp, a far ultraviolet ray represented by an excimer laser, extreme ultraviolet, an X-ray, EUV light, and the like, but also the drawing performed using particle beams such as an electron beam and an ion beam.

In the present specification, a range described using “to” includes the numerical values listed before and after “to” as a lower limit and an upper limit.

In the present specification, (meth)acrylate represents acrylate and methacrylate, (meth)acryl represents acryl and methacryl, and (meth)acryloyl represents acryloyl and methacryloyl.

In the present specification, “total solid content” of the magnetic particle-containing composition means components forming a magnetic particle-containing film. In a case where the magnetic particle-containing composition contains a solvent (such as an organic solvent or water), “total solid content” means all components except for the solvent. In addition, a liquid component is also regarded as a solid content as long as this component forms the magnetic particle-containing film.

In the present specification, a weight-average molecular weight (Mw) is a polystyrene-equivalent value obtained by a Gel Permeation Chromatography (GPC) method.

The GPC method in the present specification is based on a method using HLC-8020GPC (manufactured by Tosoh Corporation), columns consisting of TSKgel SuperHZM-H, TSKgel SuperHZ4000, and TSKgel SuperHZ2000 (manufactured by Tosoh Corporation, 4.6 mm ID×15 cm), and tetrahydrofuran (THF) as an eluent.

In the present specification, as each component, one kind of substance corresponding to each component may be used alone, or two or more kinds of substances corresponding to each component may be used in combination. Here, in a case where two or more kinds of substances are used in combination as each component, unless otherwise specified, the content of the component means the total content of the substances used in combination.

### [Magnetic Particle-Containing Composition]

The magnetic particle-containing composition according to an embodiment of the present invention (hereinafter, also simply called “composition”) contains magnetic particles having a plurality of peak tops in a particle size distribution curve showing a volume-based frequency distribution, a resin, and a solvent.

The magnetic particle-containing composition according to the embodiment of the present invention is excellent in sedimentation stability and can form a magnetic particle-containing film having excellent magnetic permeability. Details of the reason are unclear, but are assumed to be as below.

It is known that in a case where the average particle diameter of magnetic particles is not large enough, a magnetic particle-containing film formed of such magnetic particles has insufficient magnetic permeability. However, the inventors of the present invention have found that simply using magnetic particles having a large average particle diameter cannot sufficiently increase magnetic permeability because voids between the magnetic particles enlarge.

The inventors of the present invention have found that using magnetic particles having a plurality of peak tops in particle size distribution curve showing a volume-based frequency distribution makes it possible to improve magnetic permeability. Presumably, because magnetic particles having a small average particle diameter are arranged between magnetic particles having a large average particle diameter, voids between the magnetic particles in the magnetic particle-containing film may be reduced, which may improve magnetic permeability.

On the other hand, there is a problem that the magnetic particles having a large average particle diameter settle as a sediment over time in the magnetic particle-containing composition.

Regarding this problem, the inventors have found that in a case where a magnetic particle-containing composition containing magnetic particles having a plurality of peak tops in a particle size distribution curve showing a volume-based frequency distribution and a resin is used, the sedimentation of the magnetic particles can be suppressed. Presumably, because the magnetic particles having a small average particle diameter are arranged by the action of a magnetic field between the magnetic particles having a large average particle diameter, and the magnetic particles are loosely bonded together by the action of the resin, static viscosity of the magnetic particle-containing composition may be improved, which may suppress the sedimentation of the magnetic particles.

### [Magnetic Particles]

The composition contains magnetic particles having a plurality of peak tops in a particle size distribution curve showing a volume-based frequency distribution.

The material constituting the magnetic particles preferably contains a metal element. Particularly, the material preferably contains at least one kind of metal element selected from the group consisting of Fe, Ni, and Co.

The metal element may be contained in the magnetic particles, as an alloy containing a metal element (preferably a magnetic alloy), a metal oxide (preferably a magnetic oxide), a metal nitride (preferably a magnetic nitride), or a metal carbide (preferably a magnetic carbide).

The material constituting the magnetic particles may contain elements other than Fe, Ni, and Co. Specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, and N.

Specific examples of the material constituting the magnetic particles include an alloy such as Fe—Co-based alloy (preferably permendur), an Fe—Ni-based alloy (for example, permalloy), an Fe—Zr-based alloy, an Fe—Mn-based alloy, an Fe—Si based alloy, an Fe—Al based alloy, an Ni—Mo-based alloy (preferably supermalloy), an Fe—Ni—Co-based alloy, an Fe—Si—Cr—based alloy, an Fe—Si—B-based alloy, an Fe—Si—Al-based alloy (preferably sendust), an Fe—Si—B—C-based alloy, an Fe—Si—B—Cr-based alloy, an Fe—Si—B—Cr—C-based alloy, an Fe—Co—Si—B-based alloy, an Fe—Si—B—Nb-based alloy, an Fe nanocrystal alloy, an Fe-based amorphous alloy, or a Co-based amorphous alloy, and a ferrite such as a spinel ferrite (preferably an Ni—Zn-based ferrite or an Mn—Zn-based ferrite) or a hexagonal ferrite (preferably barium ferrite or a magnetoplumbite-type hexagonal ferrite represented by Formula (F1) which will be described later). The above alloys may be amorphous.

Among these, in view of higher magnetic permeability of the magnetic particle-containing film, an alloy is preferable, and a Fe-based amorphous alloy, a Fe—Si—Cr-based alloy, a Fe nanocrystal alloy, a Fe—Ni—Co-based alloy, a Co-based amorphous alloy, or a Ni—Mo-based alloy is more preferable.

Furthermore, in view of higher chemical stability of the magnetic particle-containing film, a ferrite is preferable, and a spinel ferrite is more preferable.

As the material constituting the magnetic particles, one kind of material may be used alone, or two or more kinds of materials may be used in combination.

Formula (F1) is as follows.

AFe₍₁₂₋ₓ₎AlₓO₁₉ Formula (F1)

In Formula (F1), A represents at least one kind of metal element selected from the group consisting of Sr, Ba, Ca, and Pb, and x satisfies 1.5≤×≤8.0.

In Formula (F1), as long as A is at least one kind of metal element selected from the group consisting of Sr, Ba, Ca, and Pb, the type and number of metal elements are not particularly limited.

For example, from the viewpoint of operability and handleability, A in Formula (F1) is preferably at least one kind of metal element selected from the group consisting of Sr, Ba, and Ca.

x in Formula (F1) satisfies 1.5≤x≤8.0, preferably satisfies 1.5≤x≤6.0, and more preferably satisfies 2.0≤x≤6.0.

In a case where x in Formula (F1) is 1.5 or more, radio waves in a frequency band higher than 60 GHz can be absorbed.

In a case where x in Formula (F1) is 8.0 or less, the magnetoplumbite-type hexagonal ferrite particles have magnetism.

Specific examples of the magnetoplumbite-type hexagonal ferrite represented by Formula (F1) include SrFe_{(9.58)}Al_{(2.42)}O₁₉, SrFe_{(9.37)}Al_{(2.63)}O₁₉, SrFe_{(9.27)}Al_{(2.73)}O₁₉, SrFe_{(9.85)}Al_{(2.15)}O₁₉, SrFe_{(10.00)}Al_{(2.00)}O₁₉, SrFe_{(9.74)}Al_{(2.26)}O₁₉, SrFe_{(10.44)}Al_{(1.56)}O₁₉, SrFe_{(9.79)}Al_{(2.21)}O₁₉, SrFe_{(9.33)}Al_{(2.67)}O₁₉, SrFe_{(7.88)}Al_{(4.12)}O₁₉, SrFe_{(7.04)}Al_{(4.96)}O₁₉, SrFe_{(7.37)}Al_{(4.63)}O₁₉, SrFe_{(6.25)}Al_{(5.75)}O₁₉, SrFe_{(7.71)}Al_{(4.29)}O₁₉, Sr_{(0.80)}Ba_{(0.10)}Ca_{(0.10)}Fe_{(9.83)}Al_{(2.17)}O₁₉, BaFe_{(9.50)}Al_{(2.50)}O₁₉, CaFe_{(10.00)}Al_{(2.00)}O₁₉, and PbFe_{(9.00)}Al_{(3.00)}O₁₉.

The makeup of the magnetoplumbite-type hexagonal ferrite particles is confirmed by high-frequency inductively coupled plasma (ICP) emission spectroscopy.

Specifically, a pressure-resistant container containing 12 mg of sample particles and 10 mL of a 4 mol/L (liter, the same shall be applied hereinafter) aqueous hydrochloric acid solution is kept in an oven at a set temperature of 120° C. for 12 hours, thereby obtaining a solution. Then, 30 mL of pure water is added to the obtained solution, and the solution is filtered using a 0.1 μm membrane filter. For the filtrate obtained in this way, elemental analysis is performed using a high-frequency inductively coupled plasma (ICP) emission spectrophotometer. Based on the obtained results of the elemental analysis, the content of each metal atom with respect to 100 at % of iron atoms is determined. Based on the obtained content, the makeup is confirmed.

As the measurement device, a high-frequency inductively coupled plasma (ICP) emission spectrophotometer (model number: ICPS-8100) manufactured by Shimadzu Corporation can be suitably used. However, the measurement device is not limited to this.

The magnetoplumbite-type hexagonal ferrite represented by Formula (F1) is preferably a magnetoplumbite-type hexagonal ferrite having a single phase as a crystal phase.

In the present specification, “having a single phase as a crystal phase” means that in a case where a magnetoplumbite-type hexagonal ferrite having a certain makeup is measured by powder X-Ray-Diffraction (XRD), only one kind of diffraction pattern showing the crystal structure thereof is observed. In other words, this phrase means that a case where a plurality of magnetoplumbite-type hexagonal ferrites having certain makeups coexist and two or more kinds of diffraction patterns are observed or a case where a diffraction pattern of crystals other than the magnetoplumbite-type hexagonal ferrite is observed do not occur. For the attribution of the diffraction pattern, for example, the database of the International Center for Diffraction Data (ICDD, registered trademark) can be referred to. For example, for the diffraction pattern of a magnetoplumbite-type hexagonal ferrite containing Sr, “00-033-1340” of the International Center for Diffraction Data (ICDD) can be referred to. Here, the substitution of some of iron atoms with aluminum causes the shift of peak position.

Whether the crystal phase of the magnetoplumbite-type hexagonal ferrite is a single phase can be confirmed, for example, by the X-ray diffraction (XRD) method.

Specifically, for example, a measurement method performed under the following condition by using a powder X-ray diffractometer may be used.

As the measurement device, for example, a X'Pert Pro diffractometer from Malvern Panalytical Ltd can be suitably used. However, the measurement device is not limited to this.

### Condition

X-ray source: CuKα ray
[Wavelength: 1.54 Å (0.154 nm), output: 40 mA, 45 kV]
Scan range: 20°<2θ<70°
Scan interval: 0.05°
Scan speed: 0.75°/min

The surface of each of the magnetic particles may be provided with a surface layer. In a case where the magnetic particles have a surface layer, it is possible to add functions to the magnetic particles according to the material of the surface layer.

Examples of the surface layer include an inorganic layer or an organic layer.

As a compound for forming an inorganic layer, in view of making it possible to form a surface layer excellent in at least one of the insulating properties, gas barrier properties, and chemical stability, a metal oxide, a metal nitride, a metal carbide, a phosphoric acid metal salt compound, a boric acid metal salt compound, or a silicic acid compound (for example, a silicic acid ester such as tetraethyl orthosilicate or a silicate such as sodium silicate) is preferable. Specific examples of elements contained in these compounds include Fe, Al, Ca, Mn, Zn, Mg, V, Cr, Y, Ba, Sr, Ge, Zr, Ti, Si, and rare earth elements.

Examples of the material constituting the inorganic layer obtained using the compound for forming an inorganic layer include silicon oxide, germanium oxide, titanium oxide, aluminum oxide, zirconium oxide, magnesium oxide, and the like. The inorganic layer may be a layer that contains two or more kinds of these materials.

Examples of a compound for forming an organic layer include an acrylic monomer. Specific examples of the acrylic monomer include the compounds described in paragraphs 0022 and 0023 of JP2019-67960A.

Examples of the material constituting the organic layer obtained using the compound for forming an organic layer include an acrylic resin.

The thickness of the surface layer is not particularly limited. In view of enabling the surface layer to more effectively function, the thickness of the surface layer is preferably 3 to 1,000 nm.

The magnetic particles preferably contain a metal element having a standard oxidation-reduction potential of −0.3 V or higher. In a case where the standard oxidation-reduction potential of the magnetic particles is in this range, dissolution of the magnetic particles by an acid can be suppressed, which further improves the chemical stability of the magnetic permeability of the magnetic particle-containing film.

Specific examples of metal elements having a standard oxidation-reduction potential of −0.3 V or higher include Ni and Co.

The lower limit of the standard oxidation-reduction potential of the metal element is preferably −0.3 V or higher, and particularly preferably −0.27 V or higher. The upper limit of the standard oxidation-reduction potential of the metal element is preferably 1.5 V or less.

In view of further improving the magnetic permeability of the magnetic particle-containing film, the content of the metal element having a standard oxidation-reduction potential of −0.3 V or higher with respect to the total mass of the magnetic particles is preferably 30% by mass or more, and particularly preferably 40% by mass or more. The upper limit of the content of the metal element having a standard oxidation-reduction potential of −0.3 V or higher is preferably 100% by mass or less, and particularly preferably 95% by mass or less.

In the present specification, as the value of standard oxidation-reduction potential, the value of standard oxidation-reduction potential described in Chemical Handbook (5th edition) is adopted.

In view of further improving the magnetic permeability of the magnetic particle-containing film, the content of the magnetic particles with respect to the total mass of the composition is preferably 10% by mass or more, more preferably 25% by mass or more, even more preferably 40% by mass or more, particularly preferably 50% by mass or more, and most preferably 60% by mass or more.

In view of further improving the sedimentation stability of the magnetic particles, the content of the magnetic particles with respect to the total mass of the composition is preferably 95% by mass or less, and more preferably 90% by mass or less.

In view of further improving the magnetic permeability of the magnetic particle-containing film, the content of the magnetic particles with respect to the total solid content of the composition is preferably 10% to 99% by mass, and particularly preferably 40% to 97% by mass.

### <Average Primary Particle Diameter>

The average primary particle diameter of the magnetic particles is preferably 0.001 to 100 μm, more preferably 0.01 to 50 μm, even more preferably 0.1 to 30 μm, and particularly preferably 0.5 to 25 μm.

In view of easily obtaining magnetic particles having a plurality of peak tops in a particle size distribution curve showing a volume-based frequency distribution, it is preferable to use a plurality of magnetic particles having different average primary particle diameters in combination.

The particle diameter of primary particles of the magnetic particles can be measured by imaging the magnetic particles by using a transmission electron microscope at 100,000× photographing magnification, printing the image on printing paper at total magnification of 500,000× so as to obtain an image of the particles, tracing the contour of the particles (primary particles) with a digitizer, and calculating the diameter of circles having the same area as the area of the traced regions (equivalent circular area diameter). Here, the primary particles refer to independent particles not being aggregated. The imaging using a transmission electron microscope is performed by a direct method by using a transmission electron microscope at an acceleration voltage of 300 kV. The observation and measurement with the transmission electron microscope can be performed using, for example, a transmission electron microscope H-9000 manufactured by Hitachi, Ltd. and image analysis software KS-400 manufactured by Carl Zeiss AG.

Regarding the shape of the magnetic particles, “flat” means a shape having two opposing flat surfaces. On the other hand, among the particle shapes that do not have such flat surfaces, a shape having a difference between the major axis and the minor axis is “elliptical”. The axis (straight line) along which the maximum length of a particle can be taken is determined as the major axis. In contrast, the axis along which the length of a straight line in the particle orthogonal to the major axis is maximized is determined as the minor axis. A shape having no difference between the major axis and the minor axis, that is, a shape satisfying major axis length=minor axis length is “spherical”. A shape from which the major axis and the minor axis cannot be specified is called “amorphous”. In a case where the imaging with a transmission electron microscope is used to specify the aforementioned particle shapes, the particles to be imaged are not subjected to an alignment treatment. The magnetic particles may have any of flat, elliptical, spherical, and amorphous shapes.

In a case where commercially available products are used, the catalog values are adopted as the average primary particle diameter of various particles described in the present specification.

In a case where there is no catalog value, the arithmetic mean of diameters of 500 particles randomly extracted from the image of the particles captured as described above is used.

### <Particle Size Distribution>

The magnetic particles contained in the composition have a plurality of peak tops in a particle size distribution curve showing a volume-based frequency distribution. In the present specification, the particle size distribution curve showing a volume-based frequency distribution is also called “frequency distribution curve”.

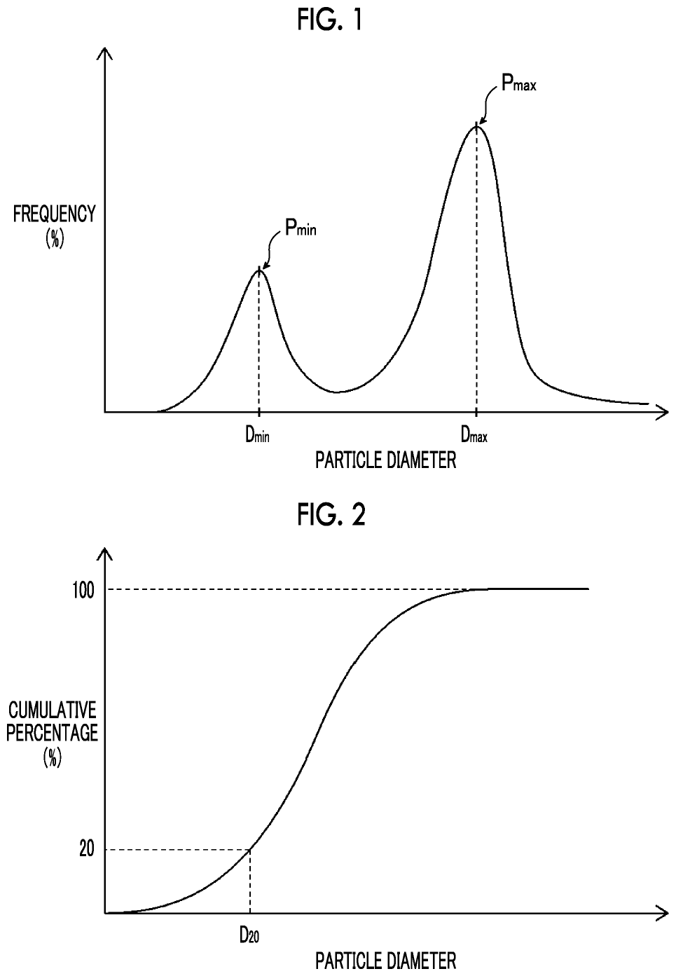

FIG. 1 is a particle size distribution graph illustrating an example of a frequency distribution curve of magnetic particles contained in the composition according to an embodiment of the present invention. As shown in FIG. 1, the frequency distribution curve is represented by a particle size distribution graph in which particle diameter is plotted on the abscissa and frequency (%) is plotted on the ordinate.

The frequency distribution curve in the present invention is obtained as follows.

First, the composition is diluted with a main solvent as necessary and ultrasonically dispersed for 60 minutes, thereby preparing a dispersion. In a case where the content of the magnetic particles in the composition is 5% by mass or less, the composition is not diluted. In a case where the content of the magnetic particles in the composition is more than 5% by mass, the composition is diluted so that the content of the magnetic particles in the diluted dispersion is 5% by mass. The main solvent means a solvent of the highest content among the solvents contained in the composition.

Next, with a laser diffraction scattering-type particle size distribution analyzer (trade name “LA960N”, manufactured by HORIBA, Ltd.) the dispersion is measured in a mode of measurement range of 0.01 μm to 5,000 μm, thereby obtaining a particle size distribution curve showing a volume-based frequency distribution of the magnetic particles contained in the composition.

The peak top in the frequency distribution curve means the maximum point in the frequency distribution curve.

In the example shown in FIG. 1, the frequency distribution curve has two peak tops, a peak top Pmin where the particle diameter is minimized and a peak top Pmax where the particle diameter is maximized. However, the number of peak tops is not limited thereto.

The number of peak tops in the frequency distribution curve is plural (that is, two or more), preferably 2 to 5, more preferably 2 to 4, even more preferably 2 or 3, and particularly preferably 2 in view of magnetic permeability and film forming properties.

In a case where Dmin represents a particle diameter at the peak top Pmin where the particle diameter is minimized and Dmax represents a particle diameter at the peak top Pmax where the particle diameter is maximized among the plurality of peak tops in the frequency distribution curve, in view of further improving the effects of the present invention, the ratio of Dmax to Dmin (Dmax/Dmin) is preferably more than 2, more preferably 3 or more, and particularly preferably 4 or more.

In view of further improving the effects of the present invention, the upper limit of the ratio (Dmax/Dmin) is preferably 150 or less, more preferably 100 or less, even more preferably 50 or less, and particularly preferably 10 or less.

For example, by using a plurality of magnetic particles having different primary particle diameters and appropriately adjusting the mixing ratio of the particles, it is possible to make the ratio (Dmax/Dmin) fall into the above range.

FIG. 2 is a particle size distribution graph illustrating an example of a particle size distribution curve showing a volume-based cumulative distribution of magnetic particles contained in the composition according to an embodiment of the present invention. As shown in FIG. 2, the particle size distribution curve showing a volume-based cumulative distribution is represented by a particle size distribution graph in which particle diameter is plotted on the abscissa and cumulative percentage (%) is plotted on the ordinate. In the present specification, the particle size distribution curve showing a volume-based cumulative distribution is also called “cumulative distribution curve”.

The cumulative distribution curve is obtained by the same method as the method used for obtaining the particle size distribution curve showing a volume-based frequency distribution.

In view of further improving the effects of the present invention, Dmin is preferably equal to or less than a particle diameter D₈₀ having a cumulative percentage of 80% in the cumulative distribution curve, and particularly preferably equal to or less than a particle diameter D₆₀ having a cumulative percentage of 60% in the cumulative distribution curve.

In view of further improving the effects of the present invention, Dmin is preferably equal to or greater than a particle diameter D₁₀ having a cumulative percentage of 10% in the cumulative distribution curve, and particularly preferably equal to or greater than a particle diameter D₂₀ having a cumulative percentage of 20% in the cumulative distribution curve.

In view of further improving the effects of the present invention, Dmin is preferably 0.1 to 50 μm, more preferably 0.5 to 25 μm, and particularly preferably 1 to 10 μm.

In view of further improving the effects of the present invention, Dmax is preferably equal to or less than a particle diameter D₉₀ having a cumulative percentage of 90% in the cumulative distribution curve, and particularly preferably equal to or less than the particle diameter D₈₀ having a cumulative percentage of 80% in the cumulative distribution curve.

In view of further improving the effects of the present invention, Dmax is preferably equal to or greater than a particle diameter D₂₀ having a cumulative percentage of 20% in the cumulative distribution curve, and particularly preferably equal to or greater than a particle diameter D₄₀ having a cumulative percentage of 40% in the cumulative distribution curve.

In view of further improving the effects of the present invention, Dmax is preferably 1 to 150 μm, more preferably 1 to 100 μm, even more preferably 5 to 75 μm, and particularly preferably 7.5 to 50 μm.

### [Resin]

The composition contains a resin.

Examples of the resin include a (meth)acrylic resin, an epoxy resin, an enethiol resin, a polycarbonate resin, a polyether resin, a polyarylate resin, a polysulfone resin, a polyethersulfone resin, a polyphenylene resin, a polyarylene ether phosphine oxide resin, a polyimide resin, a polyamide imide resin, a polyolefin resin, a cyclic olefin resin, a polyester resin, a styrene resin, a phenoxy resin, and the like. One kind of each of these resins may be used alone, or two or more kinds of these resins may be used by being mixed together. As the cyclic olefin resin, from the viewpoint of improving heat resistance, a norbornene resin is preferable. Examples of commercially available products of the norbornene resin include ARTON series manufactured by JSR Corporation (for example, ARTON F4520). Examples of the epoxy resin include an epoxy resin that is a glycidyl etherification product of a phenol compound, an epoxy resin that is a glycidyl etherification product of various novolac resins, an alicyclic epoxy resin, an aliphatic epoxy resin, a heterocyclic epoxy resin, a glycidyl ester-based epoxy resin, a glycidyl amine-based epoxy resin, an epoxy resin obtained by glycidylation of halogenated phenols, a condensate of a silicon compound having an epoxy group and another silicon compound, a copolymer of a polymerizable unsaturated compound having an epoxy group and another polymerizable unsaturated compound, and the like. As the epoxy resin, MARPROOF G-0150M, G-0105SA, G-0130SP, G-0250SP, G-1005S, G-1005SA, G-1010S, G-2050M, G-01100, and G-01758 (manufactured by NOF CORPORATION., epoxy group-containing polymers) and the like can also be used. In addition, as the resin, the resins described in Examples of WO2016/088645A can also be used. In a case where the resin has an ethylenically unsaturated group, particularly, a (meth)acryloyl group in a side chain, it is also preferable that the main chain and the ethylenically unsaturated group be bonded via a divalent linking group having an alicyclic structure.

Examples of one of the suitable aspects of the resin include a resin having a polymerizable group such as an unsaturated double bond (for example, an ethylenically unsaturated double bond), an epoxy group, or an oxetanyl group. In a case where the polymerizable group reacts in the process of forming a magnetic particle-containing film, a magnetic particle-containing film having excellent mechanical strength is obtained.

Examples of such a resin include a polymer having an epoxy group in a side chain and a polymerizable monomer or oligomer having two or more epoxy groups in the molecule. Specific examples thereof include a bisphenol A-type epoxy resin, a bisphenol F-type epoxy resin, a phenol novolac-type epoxy resin, a cresol novolac-type epoxy resin, an aliphatic epoxy resin, and the like.

As these resins, commercially available products may also be used. Furthermore, these resins may be obtained by introducing an epoxy group into a side chain of a polymer.

As for the commercially available products, for example, the description in paragraph 0191 of JP2012-155288A and the like can be referred to, and what are described in the paragraph are incorporated into the present specification.

Examples of the commercially available product also include ADEKA RESIN EP-4000S, ADEKA RESIN EP-40035, ADEKA RESIN EP-4010S, and ADEKA RESIN EP-4011S (all are manufactured by ADEKA CORPORATION), NC-2000, NC-3000, NC-7300, XD-1000, EPPN-501, and EPPN-502 (all are manufactured by ADEKA CORPORATION), JERI 031S, and the like.

Examples of commercially available products of the phenol novolac-type epoxy resin include JER-157565, JER-152, JER-154, and JER-157570 (all are manufactured by Mitsubishi Chemical Holdings Corporation.) and the like.

Specifically, as the polymer having an oxetanyl group in a side chain and the aforementioned polymerizable monomer or oligomer having two or more oxetanyl groups in the molecule, for example, ARON OXETANE OXT-121, OXT-221, OX-SQ, and PNOX (all are manufactured by TOAGOSEI CO., LTD.) can be used.

In a case where an epoxy group is introduced into a side chain of a polymer so that the resin having an epoxy group is synthesized, the introduction reaction is performed by causing the reaction in an organic solvent at a reaction temperature of 50° C. to 150° C. for a predetermined time by using, for example, a tertiary amine such as triethylamine or benzylmethylamine, a quaternary ammonium salt such as dodecyltrimethylammonium chloride, tetramethylammonium chloride, or tetraethylammonium chloride, pyridine, triphenylphosphine or the like as a catalyst. The amount of the alicyclic epoxy unsaturated compound to be introduced can be controlled so that the acid value of the obtained polymer falls into a range of 5 to 200 KOHmg/g. The weight-average molecular weight can be in a range of 500 to 5,000,000, and preferably in a range of 1,000 to 500,000.

Instead of the alicyclic epoxy unsaturated compound, it is also possible to use a compound having a glycidyl group as an epoxy group, such as glycidyl (meth)acrylate or allyl glycidyl ether. As for such a compound, for example, the description in paragraph 0045 of JP2009-265518A and the like can be referred to, and what are described in the paragraph are incorporated into the present specification.

Examples of one of the suitable aspects of the resin include a resin having an acid group, a basic group, or an amide group. The resin having an acid group, a basic group, or an amide group is suitable because this resin is likely to function as a dispersant for dispersing the magnetic particles and further improves the effects of the present invention.

Examples of the acid group include a carboxy group, a phosphoric acid group, a sulfo group, a phenolic hydroxyl group, and the like. In view of further improving the effects of the present invention, a carboxy group is preferable.

Examples of the basic group include an amino group (ammonia, a group obtained by removing one hydrogen atom from a primary amine or a secondary amine) and an imino group.

In view of further improving the effects of the present invention, it is preferable that the resin have a carboxy group or an amide group among the above.

In a case where the resin has an acid group, in view of further improving the effects of the present invention, the acid value of the resin is preferably 10 to 500 mgKOH/g, and particularly preferably 30 to 400 mgKOH/g.

In view of improving the dispersibility of the resin in the composition so that the effects of the present invention are further improved, as the resin to be used, a resin having a solubility of 10 g/L or more in a solvent is preferable, and a resin having a solubility of 20 g/L or more in a solvent is more preferable.

The upper limit of the solubility of the resin in a solvent is preferably 2,000 g/L or less, and particularly preferably 1,000 g/L or less.

The solubility of the resin in a solvent means the amount (g) of the resin dissolved in 1 L of a solvent at 25° C.

In view of further improving the effects of the present invention, the content of the resin with respect to the total mass of the composition is preferably 0.1% to 30% by mass, more preferably 1% to 20% by mass, even more preferably 2% to 15% by mass, and particularly preferably 2.5% to 10% by mass.

<Resin that Functions as Dispersant>

Examples of one of the suitable aspects of the resin include a resin that functions as a dispersant for dispersing the magnetic particles in the composition (hereinafter, this resin will be also called “dispersing resin”). In a case where the dispersing resin is used, the effects of the present invention are further improved.

Examples of suitable aspects of the dispersing resin include a resin having a repeating unit having a graft chain which will be described later, an aggregation control agent, and an anti-aggregation dispersant.

(Resin having Repeating Unit having Graft Chain)

Examples of the dispersing resin include a resin having a repeating unit having a graft chain (hereinafter, this resin will be also called “resin A”). Here, the resin A can also be used for purposes other than functioning as a dispersant.

In a case where the composition contains the resin A, in view of further improving the effects of the present invention, the content of the resin A with respect to the total mass of the composition is preferably 0.1% to 30% by mass, more preferably 0.5% to 20% by mass, and particularly preferably 1% to 10% by mass.

Repeating Unit having Graft Chain

The longer the graft chain in the repeating unit having a graft chain, the higher the effect of steric repulsion, which improves the dispersibility of the magnetic particles. In contrast, in a case where the graft chain is too long, the adsorptive force with respect to the magnetic particles is reduced, which tends to deteriorate the dispersibility of the magnetic particles. Therefore, the number of atoms constituting the graft chain excluding a hydrogen atom is preferably 40 to 10,000, more preferably 50 to 2,000, and even more preferably 60 to 500.

The graft chain mentioned herein refers to a portion from the root of the main chain (atom bonded to the main chain in a group branching off from the main chain) to the terminal of the group branching off from the main chain.

It is preferable that the graft chain contain a polymer structure. Examples of such a polymer structure include a poly(meth)acrylate structure (for example, a poly(meth)acrylic structure), a polyester structure, a polyurethane structure, a polyurea structure, a polyamide structure, a polyether structure, and the like.

In order to improve the interactivity between the graft chain and a solvent so that the dispersibility of the magnetic particles is improved, the graft chain is preferably a graft chain containing at least one kind of structure selected from the group consisting of a polyester structure, a polyether structure, and a poly(meth)acrylate structure, and more preferably a graft chain containing at least either a polyester structure or a polyether structure.

The resin A may be a resin obtained using a macromonomer having a graft chain (a monomer that has a polymer structure and is bonded to a main chain to configure a graft chain).

The macromonomer having a graft chain (monomer that has a polymer structure and is bonded to a main chain to configure a graft chain) is not particularly limited. As this macromonomer, a macromonomer containing a reactive double bond-forming group can be suitably used.

As commercially available macromonomers that correspond to the aforementioned repeating unit having a graft chain and suitably used for the synthesis of the resin A, AA-6, AA-10, AB-6, AS-6, AN-6, AW-6, AA-714, AY-707, AY-714, AK-5, AK-30, and AK-32 (all are trade names, manufactured by TOAGOSEI CO., LTD.), and BLEMMER PP-100, BLEMMER PP-500, BLEMMER PP-800, BLEMMER PP-1000, BLEMMER 55-PET-800, BLEMMER PME-4000, BLEMMER PSE-400, BLEMMER PSE-1300, and BLEMMER 43PAPE-600B (all are trade names, manufactured by NOF CORPORATION.) are used. Among these, AA-6, AA-10, AB-6, AS-6, AN-6, or BLEMMER PME-4000 is preferable.

The resin A preferably contains at least one kind of structure selected from the group consisting of polymethyl acrylate, polymethyl methacrylate, and cyclic or chain-like polyester, more preferably contains at least one kind of structure selected from the group consisting of polymethyl acrylate, polymethyl methacrylate, and chain-like polyester, and particularly preferably contains at least one kind of structure selected from the group consisting of a polymethyl acrylate structure, a polymethyl methacrylate structure, a polycaprolactone structure, and a polyvalerolactone structure. The resin A may contain only one kind of the aforementioned structure or a plurality of the aforementioned structures.

The polycaprolactone structure mentioned herein refers to a structure containing, as a repeating unit, a structure formed by ring opening of c-caprolactone. The polyvalerolactone structure refers to a structure containing, as a repeating unit, a structure formed by ring opening of δ-valerolactone.

In a case where the resin A contains repeating units represented by Formula (1) and Formula (2), which will be described later, where each of j and k is 5, the aforementioned polycaprolactone structure can be introduced into the resin A.

In a case where the resin A contains repeating units represented by Formula (1) and Formula (2), which will be described later, where each of j and k is 4, the aforementioned polyvalerolactone structure can be introduced into the resin A.

In a case where the resin A contains a repeating unit represented by Formula (4), which will be described later, where X⁵ is a hydrogen atom and R⁴ is a methyl group, the aforementioned polymethyl acrylate structure can be introduced into the resin A.

In a case where the resin A contains a repeating unit represented by Formula (4), which will be described later, where X⁵ and R⁴ both represent a methyl group, the aforementioned polymethyl methacrylate structure can be introduced into the resin A.

As the repeating unit having a graft chain that the resin A is to contain, a repeating unit represented by any of the following Formula (1) to Formula (4) is preferable, and a repeating unit represented by any of the following Formula (1A), the following Formula (2A), the following Formula (3A), the following Formula (3B), and the following Formula (4) is more preferable.

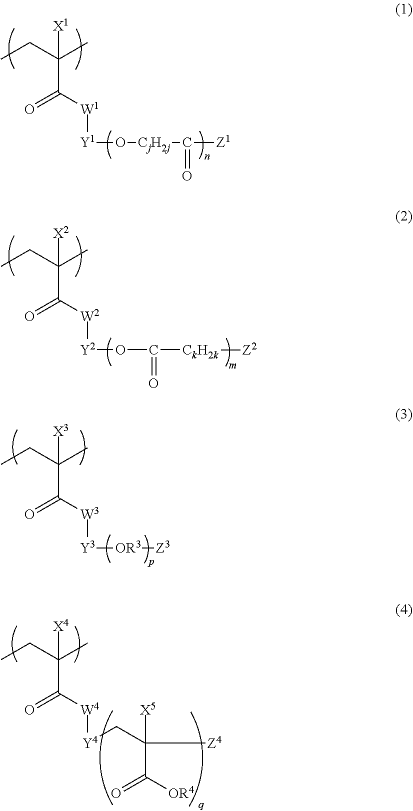

In Formulas (1) to (4), W¹, W², W³, and W⁴ each independently represent an oxygen atom or NH. W¹, W², W³, and W⁴ are preferably oxygen atoms.

In Formulas (1) to (4), X¹, X², X³, X⁴, and X⁵ each independently represent a hydrogen atom or a monovalent organic group. In view of restrictions on synthesis, X¹, X², X³, X⁴, and X⁵ preferably each independently represent a hydrogen atom or an alkyl group with a carbon number (the number of carbon atoms) of 1 to 12, more preferably each independently represent a hydrogen atom or a methyl group, and even more preferably each independently represent a methyl group.

In Formulas (1) to (4), Y¹, Y², Y³, and Y⁴ each independently represent a divalent linking group. The structure of the linking group is not particularly restricted. Specific examples of the divalent linking group represented by Y¹, Y², Y³, and Y⁴ include the following linking groups (Y-1) to (Y-21) and the like. In the following structures, A means a bonding site to the left terminal group in Formulas (1) to (4), and B means a bonding site to the right terminal group in Formulas (1) to (4). Among the following structures, in view of ease of synthesis, (Y-2) or (Y-13) is more preferable.

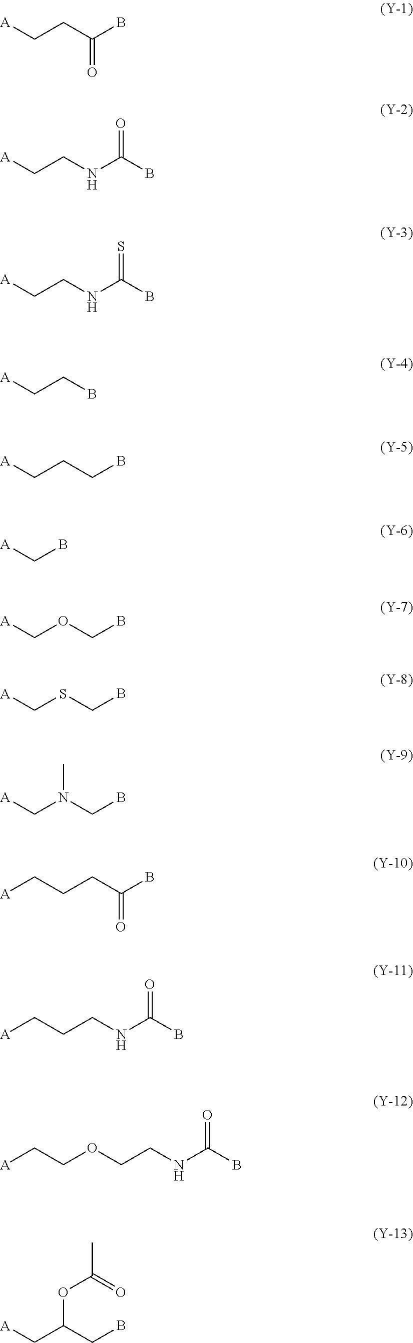

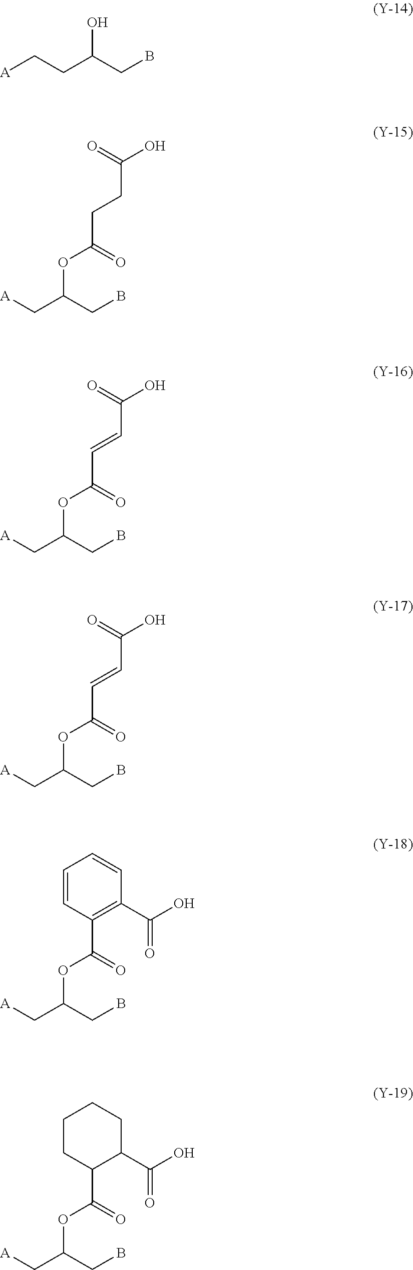

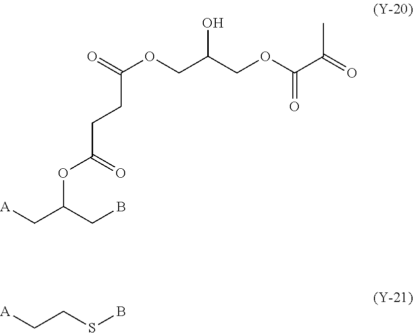

In Formulas (1) to (4), Z¹, Z², Z³, and Z⁴ each independently represent a monovalent organic group. The structure of the organic group is not particularly limited. Specific examples of the organic group include an alkyl group, a hydroxyl group, an alkoxy group, an aryloxy group, a heteroaryloxy group, an alkylthioether group, an arylthioether group, a heteroarylthioether group, an amino group, and the like. Among these, as the organic group represented by Z¹, Z², Z³, and Z⁴, particularly, in view of improving dispersibility, a group that brings about a steric repulsion effect is preferable. Z¹, Z², Z³, and Z⁴ more preferably each independently represent an alkyl or alkoxy group with a carbon number of 5 to 24. Especially, Z¹, Z², Z³, and Z⁴ even more preferably each independently represent a branched alkyl group with a carbon number of 5 to 24, a cyclic alkyl group with a carbon number of 5 to 24, or an alkoxy group with a carbon number of 5 to 24. Note that the alkyl group contained in the alkoxy group may be linear, branched, or cyclic.

In Formulas (1) to (4), n, m, p, and q each independently represent an integer of 1 to 500.

In Formulas (1) and (2), j and k each independently represent an integer of 2 to 8. Each of j and k in Formulas (1) and (2) is preferably an integer of 4 to 6, and more preferably 5.

In Formulas (1) and (2), each of n and m is preferably an integer of 10 or more, and more preferably an integer of 20 or more. In a case where the resin A contains a polycaprolactone structure and a polyvalerolactone structure, the sum of the repetition number of the polycaprolactone structure and the repetition number of polyvalerolactone is preferably an integer of 10 or more, and more preferably an integer of 20 or more.

In Formula (3), R³ represents a branched or linear alkylene group which is preferably an alkylene group with a carbon number of 1 to 10, and more preferably an alkylene group with a carbon number of 2 or 3. In a case where p is 2 to 500, a plurality of R³'s may be the same or different from each other.

In Formula (4), R⁴ represents a hydrogen atom or a monovalent organic group, and the structure of the monovalent organic group is not particularly limited. R⁴ is preferably a hydrogen atom, an alkyl group, an aryl group, or a heteroaryl group, and more preferably a hydrogen atom or an alkyl group. In a case where R⁴ is an alkyl group, the alkyl group is preferably a linear alkyl group with a carbon number of 1 to 20, a branched alkyl group with a carbon number of 3 to 20, or a cyclic alkyl group with a carbon number of 5 to 20, more preferably a linear alkyl group with a carbon number of 1 to 20, and even more preferably a linear alkyl group with a carbon number of 1 to 6. In a case where q in Formula (4) is 2 to 500, a plurality of X⁵'s and R⁴'s in the graft chain may be the same or different from each other.

The resin A may contain two or more kinds of repeating units having different structures and having a graft chain. That is, the molecule of the resin A may contain repeating units represented by Formulas (1) to (4) having different structures. Furthermore, in a case where n, m, p, and q in Formulas (1) to (4) each represent an integer of 2 or more, the side chains in Formulas (1) and (2) may contain structures where j and k represent different integers, and a plurality of R³'s, R⁴'s, and X⁵'s in the molecules of Formulas (3) and (4) may be the same or different from each other.

The repeating unit represented by Formula (1) is preferably a repeating unit represented by the following Formula (1A).

The repeating unit represented by Formula (2) is preferably a repeating unit represented by the following Formula (2A).

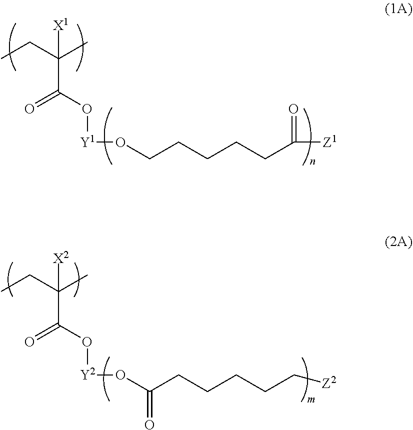

X¹, Y¹, Z¹, and n in Formula (1A) have the same definitions as X¹, Y¹, Z¹, and n in Formula (1), and preferable ranges thereof are the same as well. X², Y², Z², and m in Formula (2A) have the same definitions as X², Y², Z², and m in Formula (2), and preferable ranges thereof are the same as well.

The repeating unit represented by Formula (3) is more preferably a repeating unit represented by the following Formula (3A) or the following Formula (3B).

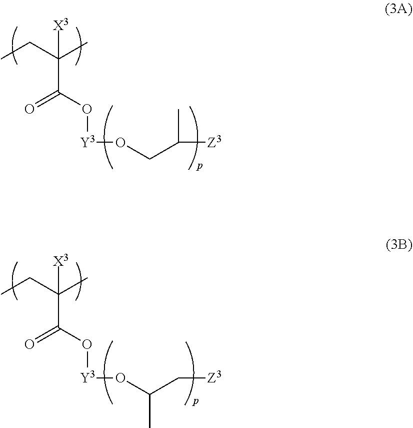

X³, Y³, Z³, and p in Formula (3A) or (3B) have the same definitions as X³, Y³, Z³, and p in Formula (3), and preferable ranges thereof are the same as well.

It is more preferable that the resin A contain the repeating unit represented by Formula (1A) as the repeating unit having a graft chain.

It is also preferable that the resin A contain a repeating unit containing a polyalkylene imine structure and a polyester structure. It is preferable that the repeating unit containing a polyalkylene imine structure and a polyester structure contain the polyalkylene imine structure in the main chain and contain the polyester structure as a graft chain.

The polyalkylene imine structure is a polymerization structure having two or more identical or different alkylene imine chains. Specific examples of the alkylene imine chain include alkylene imine chains represented by the following Formula (4A) and the following Formula (4B).

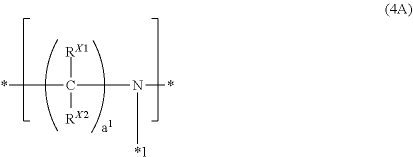

In Formula (4A), R^{x1} and R^{x2} each independently represent a hydrogen atom or an alkyl group. a¹ represents an integer of 2 or more. ^{*1} represents a bonding position to a polyester chain, an adjacent alkylene imine chain, a hydrogen atom, or a substituent.

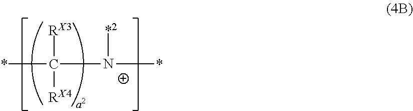

In Formula (4B), R^{x3} and R^{x4} each independently represent a hydrogen atom or an alkyl group. a² represents an integer of 2 or more. The alkylene imine chain represented by Formula (4B) is bonded to a polyester chain having an anionic group by the formation of a salt crosslinking group of N⁺ shown in Formula (4B) and an anionic group contained in the polyester chain.

* in Formula (4A) and Formula (4B) and ^{*2} in Formula (4B) each independently represent a position to be bonded to an adjacent alkylene imine chain, a hydrogen atom, or a substituent.

* in Formula (4A) and Formula (4B) particularly preferably represent a position to be bonded to an adjacent alkylene imine chain.

R^{X1} and R^{X2} in Formula (4A) and R^{X3} and R^{X4} in Formula (4B) each independently represent a hydrogen atom or an alkyl group.

The carbon number of the alkyl group is preferably 1 to 6, and more preferably 1 to 3.

It is preferable that R^{x1} and R^{x2} in Formula (4A) both represent a hydrogen atom.

It is preferable that R^{x3} and R^{x4} in Formula (4B) both represent a hydrogen atom.

a¹ in Formula (4A) and a² in Formula (4B) are not particularly limited as long as a¹ and a² each represent an integer of 2 or more. The upper limit of a¹ and a² is preferably 10 or less, more preferably 6 or less, even more preferably 4 or less, still more preferably 2 or 3, and particularly preferably 2.

* in Formula (4A) and Formula (4B) represents a bonding position to an adjacent alkylene imine chain, a hydrogen atom, or a substituent.

Examples of the aforementioned substituent include a substituent such as an alkyl group (for example, an alkyl group with a carbon number of 1 to 6). Furthermore, a polyester chain may be bonded thereto as a substituent.

The alkylene imine chain represented by Formula (4A) is preferably linked to the polyester chain at the position represented by ^{*1} described above. Specifically, it is preferable that the carbonyl carbon in the polyester chain be bonded at the position represented by ^{*1} described above.

Examples of the polyester chain include a polyester chain represented by the following formula (5A).

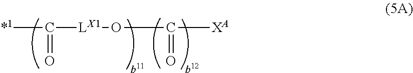

In a case where the alkylene imine chain is an alkylene imine chain represented by Formula (4B), it is preferable that the polyester chain contain an anion (preferably an oxygen anion O⁻), and that the anion and N⁺ in Formula (4B) form a salt crosslinking group.

Examples of such a polyester chain include a polyester chain represented by the following Formula (5B).

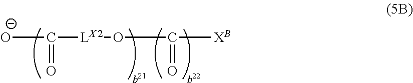

L^{X1} in Formula (5A) and L^{X2} in Formula (5B) each independently represent a divalent linking group. Preferable examples of the divalent linking group include an alkylene group with a carbon number of 3 to 30.

b¹¹ in Formula (5A) and b²¹ in Formula (5B) each independently represent an integer of 2 or more. The upper limit thereof is, for example, 200 or less.

b¹² in Formula (5A) and b²² in Formula (5B) each independently represent 0 or 1.

X^{A} in Formula (5A) and X^{B} in Formula (5B) each independently represent a hydrogen atom or a substituent. Examples of the substituent include an alkyl group, an alkoxy group, a polyalkyleneoxyalkyl group, an aryl group, and the like.

The carbon number of the aforementioned alkyl group (the alkyl group may be any of linear, branch, and cyclic alkyl groups) and the carbon number of an alkyl group (the alkyl group may be any of linear, branch, and cyclic alkyl groups) contained in the aforementioned alkoxy group are, for example, 1 to 30, and preferably 1 to 10. The aforementioned alkyl group may further have a substituent. Examples of the substituent include a hydroxyl group and a halogen atom (the halogen atom includes a fluorine atom, a chlorine atom, a bromine atom, an iodine atom, and the like).

The polyalkyleneoxyalkyl group is a substituent represented by R^{X6}(OR^{X7})ₚ(O)_{q-}. R^{X6} represents an alkyl group, R^{X7} represents an alkylene group, p represents an integer of 2 or more, and q represents 0 or 1.

The alkyl group represented by R^{X6} has the same definition as the alkyl group represented by X^{A}. Examples of the alkylene group represented by R^{X7} include a group obtained by removing one hydrogen atom from the alkyl group represented by X^{A}.

p is an integer of 2 or more, and the upper limit thereof is, for example, 10 or less, and preferably 5 or less.

Examples of the aryl group include an aryl group (which may be monocyclic or polycyclic) with a carbon number of 6 to 24.

The aforementioned aryl group may further have a substituent. Examples of the substituent include an alkyl group, a halogen atom, a cyano group, and the like.

The aforementioned polyester chain is preferably a structure established by ring opening of lactones such as ϵ-caprolactone, δ-caprolactone, β-propiolactone, γ-butyrolactone, δ-valerolactone, γ-valerolactone, enanthonolactone, β-butyrolactone, γ-hexanolactone, and γ-octanolactone, δ-hexanolactone, δ-octanolactone, δ-dodecanolactone, α-methyl-γ-butyrolactone, and lactide (which may be L-lactide or D-lactide), and more preferably a structure established by ring opening of ϵ-caprolactone or δ-valerolactone.

The aforementioned repeating unit containing a polyalkylene imine structure and a polyester structure can be synthesized according to the synthesis method described in JP5923557B.

In the resin A, the content of the repeating unit having a graft chain expressed in terms of mass with respect to the total mass of the resin A is preferably 2% to 95% by mass, more preferably 2% to 90% by mass, and particularly preferably 5% to 30% by mass. In a case where the content of the repeating unit having a graft chain is in this range, the effects of the present invention are further improved.

### Hydrophobic Repeating Unit

The resin A may contain a hydrophobic repeating unit that is different from the repeating unit having a graft chain (that is, does not correspond to the repeating unit having a graft chain). In the present specification, the hydrophobic repeating unit refers to a repeating unit having no acid group (for example, a carboxylic acid group, a sulfonic acid group, a phosphoric acid group, a phenolic hydroxyl group, and the like).

The hydrophobic repeating unit is preferably a repeating unit derived from (corresponding to) a compound (monomer) having a ClogP value of 1.2 or more, and is more preferably a repeating unit derived from a compound having a ClogP value of 1.2 to 8. In a case where this hydrophobic repeating unit is used, the effects of the present invention can be more reliably expressed.

The ClogP value is a value calculated by a program “CLOGP” available from Daylight Chemical Information System, Inc. This program provides a value of “calculated logP” calculated by the fragment approach (see the following documents) of Hansch and Leo. The fragment approach is based on the chemical structure of a compound. In this method, the chemical structure is divided into partial structures (fragments), and degrees of contribution to logP that are assigned to the fragments are summed up, thereby estimating the logP value of the compound. Details of the method are described in the following documents. In the present specification, a ClogP value calculated by a program CLOGP v 4.82 is used.

A. J. Leo, Comprehensive Medicinal Chemistry, Vol. 4, C. Hansch, P. G. Sammnens,

J. B. Taylor and C. A. Ramsden, Eds., p. 295, Pergamon press, 1990, C. Hansch & A. J. Leo. Substituent Constants For Correlation Analysis in Chemistry and Biology. John Wiley & Sons. A. J. Leo. Calculating logPoct from structure. Chem. Rev., 93, 1281-1306, 1993.

logP means a common logarithm of a partition coefficient P. logP is a value of physical properties that shows how a certain organic compound is partitioned in an equilibrium of two-phase system consisting of oil (generally, 1-octanol) and water by using a quantitative numerical value. logP is represented by the following equation.

logP=log(Coil/Cwater)

In the formula, Coil represents a molar concentration of a compound in an oil phase, and Cwater represents a molar concentration of the compound in a water phase.

The greater the positive logP value based on 0, the higher the oil solubility. The greater the absolute value of negative logP, the higher the water solubility. The value of logP is negatively correlated with the water solubility of an organic compound, and widely used as a parameter for estimating the hydrophilicity and hydrophobicity of an organic compound.

It is preferable that the resin A contain, as the hydrophobic repeating unit, one or more kinds of repeating units selected from repeating units derived from the monomers represented by the following Formulas (i) to (iii).

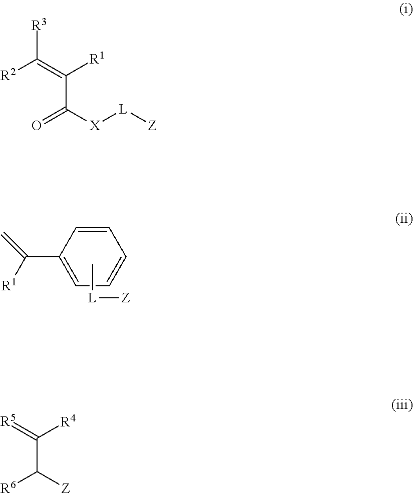

In the above Formulas (i) to (iii), R¹, R², and R³ each independently represent a hydrogen atom, a halogen atom (for example, a fluorine atom, a chlorine atom, a bromine atom, or the like), or an alkyl group with a carbon number of 1 to 6 (for example, a methyl group, an ethyl group, a propyl group, or the like).

Each of R¹, R², and R³ is preferably a hydrogen atom or an alkyl group with a carbon number of 1 to 3, and more preferably a hydrogen atom or a methyl group. Each of R² and R³ is even more preferably a hydrogen atom.

X represents an oxygen atom (—O—) or an imino group (—NH—), and is preferably an oxygen atom.

L represents a single bond or a divalent linking group. Examples of the divalent linking group include a divalent aliphatic group (for example, an alkylene group, a substituted alkylene group, an alkenylene group, a substituted alkenylene group, an alkynylene group, or a substituted alkynylene group), a divalent aromatic group (for example, an arylene group or a substituted arylene group), a divalent heterocyclic group, an oxygen atom (—O—), a sulfur atom (—S—), an imino group (—NH—), a substituted imino group (—NR³¹—, where R³¹ is an aliphatic group, an aromatic group, or a heterocyclic group), a carbonyl group (—CO—), a combination of these, and the like.

The divalent aliphatic group may have a cyclic structure or a branched structure. The carbon number of the aliphatic group is preferably 1 to 20, more preferably 1 to 15, and even more preferably 1 to 10. The aliphatic group may be an unsaturated aliphatic group or a saturated aliphatic group, and is preferably a saturated aliphatic group. Furthermore, the aliphatic group may have a substituent. Examples of the substituent include a halogen atom, an aromatic group, a heterocyclic group, and the like.

The carbon number of the divalent aromatic group is preferably 6 to 20, more preferably 6 to 15, and even more preferably 6 to 10. Furthermore, the aromatic group may have a substituent. Examples of the substituent include a halogen atom, an aliphatic group, an aromatic group, a heterocyclic group, and the like.

It is preferable that the divalent heterocyclic group contain a 5-membered ring or a 6-membered ring as the heterocycle. Another heterocycle, aliphatic ring, or aromatic ring may be condensed with the heterocycle. Furthermore, the heterocyclic group may have a substituent. Examples of the substituent include a halogen atom, a hydroxyl group, an oxo group (═O), a thioxo group (═S), an imino group (═NH), a substituted imino group (═N—R³², where R³² is an aliphatic group, an aromatic group, or a heterocyclic group), an aliphatic group, an aromatic group, and a heterocyclic group.

L is preferably a single bond or a divalent linking group containing an alkylene group or an oxyalkylene structure. The oxyalkylene structure is more preferably an oxyethylene structure or an oxypropylene structure. Furthermore, L may contain a polyoxyalkylene structure containing two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—. n is preferably an integer of 2 or more, and more preferably an integer of 2 to 10.

Examples of Z include an aliphatic group (for example, an alkyl group, a substituted alkyl group, an unsaturated alkyl group, or a substituted unsaturated alkyl group), an aromatic group (for example, an aryl group, a substituted aryl group, an arylene group, or a substituted arylene group), a heterocyclic group, and a combination of these. These groups may contain an oxygen atom (—O—), a sulfur atom (—S—), an imino group (—NH—), a substituted imino group (—NR³¹—, where R³¹ is an aliphatic group, an aromatic group, or a heterocyclic group), or a carbonyl group (—CO—).

The aliphatic group may have a cyclic structure or a branched structure. The carbon number of the aliphatic group is preferably 1 to 20, more preferably 1 to 15, and even more preferably 1 to 10. The aliphatic group further contains a ring assembly hydrocarbon group and a crosslinked cyclic hydrocarbon group. Examples of the ring assembly hydrocarbon group include a bicyclohexyl group, a perhydronaphthalenyl group, a biphenyl group, a 4-cyclohexylphenyl group, and the like. Examples of a crosslinked cyclic hydrocarbon ring include a bicyclic hydrocarbon ring such as a pinane, bornane, norpinane, norbornane, or bicyclooctane ring (such as a bicyclo[2.2.2]octane ring or a bicyclo[3.2.1]octane ring), a tricyclic hydrocarbon ring such as a homobredane, adamantane, tricyclo[5.2.1.0^{2,6}]decane, or tricyclo[4.3.1.1^{2,5}]undecane ring, a tetracyclic hydrocarbon ring such as a tetracyclo [4.4.0.1^{2,5}.1^{7,10}]dodecane or perhydro-1,4-methano-5,8-methanonaphthalene ring, and the like. In addition, the crosslinked cyclic hydrocarbon ring also includes fused hydrocarbon rings, for example, fused rings consisting of a plurality of condensed 5- to 8-membered cycloalkane rings such as perhydronaphthalene (decalin), perhydroanthracene, perhydrophenanthrene, perhydroacenaphtene, perhydrofluorene, perhydroindene, and perhydrophenanthrene rings.

As the aliphatic group, a saturated aliphatic group is preferred over an unsaturated aliphatic group. Furthermore, the aliphatic group may have a substituent. Examples of the substituent thereof include a halogen atom, an aromatic group, and a heterocyclic group. Here, the aliphatic group does not have an acid group as a substituent.

The carbon number of the aromatic group is preferably 6 to 20, more preferably 6 to 15, and even more preferably 6 to 10. Furthermore, the aromatic group may have a substituent. Examples of the substituent include a halogen atom, an aliphatic group, an aromatic group, and a heterocyclic group. Here, the aromatic group does not have an acid group as a substituent.

It is preferable that the heterocyclic group contain a 5-membered ring or a 6-membered ring as the heterocycle. Another heterocycle, aliphatic ring, or aromatic ring may be condensed with the heterocycle. Furthermore, the heterocyclic group may have a substituent. Examples of the substituent include a halogen atom, a hydroxyl group, an oxo group (═O), a thioxo group (═S), an imino group (═NH), a substituted imino group (═N—R³², where R³² is an aliphatic group, an aromatic group, or a heterocyclic group), an aliphatic group, an aromatic group, and a heterocyclic group. Here, the heterocyclic group does not have an acid group as a substituent.

In the above Formula (iii), R⁴, R⁵, and R⁶ each independently represent a hydrogen atom, a halogen atom (for example, a fluorine atom, a chlorine atom, a bromine atom, or the like), an alkyl group with a carbon number of 1 to 6 (for example, a methyl group, an ethyl group, a propyl group, or the like), Z, or L-Z. Here, L and Z have the same definition as the aforementioned groups represented by L and Z. Each of R⁴, R⁵, and R⁶ is preferably a hydrogen atom or an alkyl group with a carbon number of 1 to 3, and more preferably a hydrogen atom.

As the monomer represented by the above Formula (i), a compound is preferably in which each of R¹, R², and R³ is a hydrogen atom or a methyl group, L is a single bond or a divalent linking group containing an alkylene group or an oxyalkylene structure, X is an oxygen atom or an imino group, and Z is an aliphatic group, a heterocyclic group, or an aromatic group.

As the monomer represented by the above Formula (ii), a compound is preferable in which R¹ is a hydrogen atom or a methyl group, L is an alkylene group, and Z is an aliphatic group, a heterocyclic group, or an aromatic group. Furthermore, as the monomer represented by the above Formula (iii), a compound is preferable in which each of R⁴, R⁵, and R⁶ is a hydrogen atom or a methyl group, and Z is an aliphatic group, a heterocyclic group, or an aromatic group.

Examples of typical compounds represented by Formulas (i) to (iii) include a radically polymerizable compound selected from acrylic acid esters, methacrylic acid esters, styrenes, and the like.

As examples of the typical compounds represented by Formulas (i) to (iii), the compounds described in paragraphs 0089 to 0093 of JP2013-249417A can be referred to, and what are described in the paragraphs are incorporated into the present specification.

In the resin A, the content of the hydrophobic repeating unit, expressed in terms of mass, with respect to the total mass of the resin A is preferably 10% to 90% by mass, and more preferably 20% to 80% by mass.

Functional Group Capable of Interacting with Magnetic Particles

The resin A may have a functional group capable of interacting with the magnetic particles.

It is preferable that the resin A further contain a repeating unit containing a functional group that is capable of interacting with the magnetic particles.

Examples of the functional group capable of interacting with the magnetic particles include an acid group, a basic group, a coordinating group, a reactive functional group, and the like.

In a case where the resin A contains an acid group, a basic group, a coordinating group, or a reactive functional group, it is preferable that the resin A contain a repeating unit containing an acid group, a repeating unit containing a basic group, a repeating unit containing a coordinating group, or a repeating unit having a reactive functional group.

The repeating unit containing an alkali-soluble group as an acid group may be a repeating unit that is the same as or different from the aforementioned repeating unit having a graft chain. However, the repeating unit containing an alkali-soluble group as an acid group is a repeating unit different from the aforementioned hydrophobic repeating unit (that is, does not correspond to the aforementioned hydrophobic repeating unit).

Examples of the acid group which is a functional group capable of interacting with the magnetic particles include a carboxylic acid group, a sulfonic acid group, a phosphoric acid group, a phenolic hydroxyl group, and the like. The acid group is preferably at least one kind of group among a carboxylic acid group, a sulfonic acid group, and a phosphoric acid group, and more preferably a carboxylic acid group. The carboxylic acid group has excellent adsorptive force with respect to the magnetic particles and has high dispersibility.

That is, it is preferable that the resin A further contain a repeating unit containing at least one kind of group among a carboxylic acid group, a sulfonic acid group, and a phosphoric acid group.

The resin A may have one kind of repeating unit containing an acid group or two or more kinds of such repeating units.

In a case where the resin A contains the repeating unit containing an acid group, the content of the repeating unit expressed in terms of mass with respect to the total mass of the resin A is preferably 5% to 80% by mass, and more preferably 10% to 60% by mass.

Examples of the basic group which is a functional group capable of interacting with the magnetic particles include a primary amino group, a secondary amino group, a tertiary amino group, a heterocycle containing a N atom, an amide group, and the like. As the basic group, in view of excellent adsorptive force with respect to the magnetic particles and high dispersibility, a tertiary amino group is preferable. The resin A may contain one kind of basic group described above or two or more kinds of basic groups described above.

In a case where the resin A contains the repeating unit containing a basic group, the content of the repeating unit expressed in terms of mass with respect to the total mass of the resin A is preferably 0.01% to 50% by mass, and more preferably 0.01% to 30% by mass.

Examples of the coordinating group and the reactive functional group which are functional groups capable of interacting with the magnetic particles include an acetylacetoxy group, a trialkoxysilyl group, an isocyanate group, an acid anhydride, an acid chloride, and the like. As these functional groups, in view of excellent adsorptive force with respect to the magnetic particles and high dispersibility of the magnetic particles, an acetylacetoxy group is preferable. The resin A may have one kind of these groups or two or more kinds of these groups.

In a case where the resin A contains the repeating unit containing a coordinating group or the repeating unit containing a reactive functional group, the content of the repeating unit expressed in terms of mass with respect to the total mass of the resin A is preferably 10% to 80% by mass, and more preferably 20% to 60% by mass.

In a case where the resin A contains, in addition to a graft chain, a functional group capable of interacting with the magnetic particles, the resin A may contain a functional group capable of interacting with various magnetic particles described above, and the way the functional group is introduced into the resin A is not particularly limited. For example, It is preferable that the resin to be incorporated into the composition contain one or more kinds of repeating units selected from repeating units derived from the monomers represented by the following Formulas (iv) to (vi).

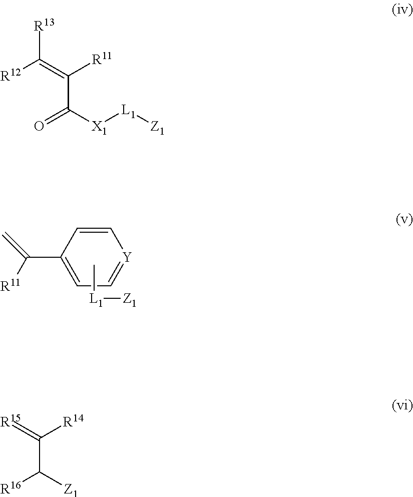

In Formulas (iv) to (vi), R¹¹, R¹², and R¹³ each independently represent a hydrogen atom, a halogen atom (for example, a fluorine atom, a chlorine atom, a bromine atom, or the like), or an alkyl group with a carbon number of 1 to 6 (for example, a methyl group, an ethyl group, a propyl group, or the like).

In Formulas (iv) to (vi), each of R¹¹, R¹², and R¹³ is preferably a hydrogen atom or an alkyl group with a carbon number of 1 to 3, and more preferably a hydrogen atom or a methyl group. Each of R¹² and R¹³ in General Formula (iv) is even more preferably a hydrogen atom.

X₁ in Formula (iv) represents an oxygen atom (—O—) or an imino group (—NH—), and is preferably an oxygen atom.

Y in Formula (v) represents a methine group or a nitrogen atom.

L₁ in Formulas (iv) to (v) represents a single bond or a divalent linking group. The divalent linking group has the same definition as the divalent linking group represented by L in Formula (i) described above.

L₁ is preferably a single bond or a divalent linking group containing an alkylene group or an oxyalkylene structure. The oxyalkylene structure is more preferably an oxyethylene structure or an oxypropylene structure. Furthermore, L₁ may contain a polyoxyalkylene structure including two or more repeating oxyalkylene structures. As the polyoxyalkylene structure, a polyoxyethylene structure or a polyoxypropylene structure is preferable. The polyoxyethylene structure is represented by —(OCH₂CH₂)n-. n is preferably an integer of 2 or more, and more preferably an integer of 2 to 10.

In Formulas (iv) to (vi), Z₁ represents a functional group that is capable of interacting with the magnetic particles as well in addition to the graft chain. Z₁ is preferably a carboxylic acid group or a tertiary amino group, and more preferably a carboxylic acid group.

In Formula (vi), R¹⁴, R¹⁵, and R¹⁶ each independently represent a hydrogen atom, a halogen atom (for example, a fluorine atom, a chlorine atom, a bromine atom, or the like), an alkyl group with a carbon number of 1 to 6 (for example, a methyl group, an ethyl group, a propyl group, or the like), —Z₁, or L₁—Z₁. Here, L₁ and Z₁ have the same definitions as L₁ and Z₁ described above, and preferable examples thereof are also the same. Each of R¹⁴, R¹⁵, and R¹⁶ is preferably a hydrogen atom or an alkyl group with a carbon number of 1 to 3, and more preferably a hydrogen atom.

As the monomer represented by Formula (iv), a compound is preferable in which R¹¹, R¹², and R¹³ each independently represent a hydrogen atom or a methyl group, L₁ is a divalent linking group containing an alkylene group or an oxyalkylene structure, X₁ is an oxygen atom or an imino group, and Z₁ is a carboxylic acid group.

As the monomer represented by Formula (v), a compound is preferable in which R¹¹ is a hydrogen atom or a methyl group, L₁ is an alkylene group, Z₁ is a carboxylic acid group, and Y is a methine group.

Furthermore, as the monomer represented by Formula (vi), a compound is preferable in which R¹⁴, R¹⁵, and R¹⁶ each independently represent a hydrogen atom or a methyl group, and Z₁ is a carboxylic acid group.

Typical examples of the monomers (compounds) represented by Formulas (iv) to (vi) will be shown below.

Examples of the monomers include methacrylic acid, crotonic acid, isocrotonic acid, a reactant of a compound containing an addition-polymerizable double bond and a hydroxyl group in a molecule (for example, 2-hydroxyethyl methacrylate) and a succinic anhydride, a reactant of a compound containing an addition-polymerizable double bond and a hydroxyl group in a molecule and a phthalic anhydride, a reactant of a compound containing an addition-polymerizable double bond and a hydroxyl group in a molecule and a tetrahydroxyphthalic anhydride, a reactant of a compound containing an addition-polymerizable double bond and a hydroxyl group in a molecule and a trimellitic anhydride, a reactant of a compound containing an addition-polymerizable double bond and a hydroxyl group in a molecule and a pyromellitic anhydride, acrylic acid, an acrylic acid dimer, an acrylic acid oligomer, maleic acid, itaconic acid, fumaric acid, 4-vinylbenzoic acid, vinylphenol, 4-hydroxyphenyl methacrylamide, and the like.

In view of interaction with the magnetic particles, temporal stability, and permeability with respect to a developer, the content of the repeating unit containing a functional group capable of interacting with the magnetic particles, the content being expressed in terms of mass, with respect to the total mass of the resin A is preferably 0.05% to 90% by mass, more preferably 1.0% to 80% by mass, and even more preferably 10% to 70% by mass.

### Ethylenically Unsaturated Group

The resin A may contain an ethylenically unsaturated group.

The ethylenically unsaturated group is not particularly limited, and examples thereof include a (meth)acryloyl group, a vinyl group, a styryl group, and the like. Among these, a (meth)acryloyl group is preferable.

Particularly, the resin A preferably contains a repeating unit that contains an ethylenically unsaturated group in a side chain, and more preferably contains a repeating unit that contains an ethylenically unsaturated group in a side chain and is derived from (meth)acrylate (hereinafter, such a repeating unit will be also called “(meth)acrylic repeating unit containing an ethylenically unsaturated group in a side chain”).

The (meth)acrylic repeating unit containing an ethylenically unsaturated group in a side chain is obtained, for example, by causing an addition reaction between a carboxylic acid group in the resin A containing a (meth)acrylic repeating unit containing the carboxylic acid group and an ethylenically unsaturated compound containing a glycidyl group or an alicyclic epoxy group. Reacting the ethylenically unsaturated group (a glycidyl group or an alicyclic epoxy group) introduced in this way makes it possible to obtain a (meth)acrylic repeating unit containing an ethylenically unsaturated group in a side chain.

In a case where the resin A contains the repeating unit containing an ethylenically unsaturated group, the content of the repeating unit expressed in terms of mass with respect to the total mass of the resin A is preferably 30% to 70% by mass, and more preferably 40% to 60% by mass.

### Other Repeating Units

For the purpose of improving various performances such as film forming performance, as long as the effects of the present invention are not impaired, the resin A may further have other repeating units having various performances different from the repeating unit having a graft chain, the hydrophobic repeating unit, and the repeating unit containing a functional group capable of interacting with the magnetic particles.

Examples of those other repeating units include repeating units derived from radically polymerizable compounds selected from acrylonitriles, methacrylonitriles, and the like.

For the resin A, one kind of those other repeating units or two or more kinds of those other repeating units can be used. The content of those other repeating units expressed in terms of mass with respect to the total mass of the resin A is preferably 0% to 80% by mass, and more preferably 10% to 60% by mass.

### Physical Properties of Resin A

The acid value of the resin A is not particularly limited. For example, the acid value is preferably 0 to 400 mgKOH/g, more preferably 10 to 350 mgKOH/g, even more preferably 30 to 300 mgKOH/g, and particularly preferably in a range of 50 to 200 mgKOH/g.

In a case where the acid value of the resin A is 50 mgKOH/g or more, the sedimentation stability of the magnetic particles can be further improved.

In the present specification, the acid value can be calculated, for example, from the average content of acid groups in a compound. Furthermore, changing the content of the repeating unit containing an acid group in the resin makes it possible to obtain a resin having a desired acid value.

The weight-average molecular weight of the resin A is not particularly limited. For example, the weight-average molecular weight is preferably 3,000 or more, more preferably 4,000 or more, even more preferably 5,000 or more, and particularly preferably 6,000 or more. The upper limit of the weight-average molecular weight is, for example, preferably 300,000 or less, more preferably 200,000 or less, even more preferably 100,000 or less, and particularly preferably 50,000 or less.

The resin A can be synthesized based on a known method.

For specific examples of the resin A, the polymer compounds described in paragraphs 0127 to 0129 of JP2013-249417A can be referred to, and what are described in the paragraphs are incorporated into the present specification.

As the resin A, the graft copolymers in paragraphs 0037 to 0115 of JP2010-106268A (paragraphs 0075 to 0133 of US2011/0124824 corresponding to JP2010-106268A) can also be used, and what are described in the paragraphs can be cited and incorporated into the present specification.

### (Aggregation Control Agent)

Examples of the dispersing resin include an aggregation control agent.

The aggregation control agent has functions of being bonded to aggregates having a relatively high density, such as the magnetic particles, and dispersing optionally added other components (for example, the alkali-soluble resin and the like) in the composition so that bulky aggregates can be formed.

In a case where the dispersing resin includes an aggregation control agent, the magnetic particles in the composition are inhibited from forming a hard cake, and bulky aggregates are formed. Therefore, redispersibility can be improved.

Examples of the aggregation control agent include a cellulose derivative.

Examples of the cellulose derivative include carboxymethyl cellulose, methyl cellulose, hydroxyethyl cellulose, hydroxypropyl cellulose, hydroxypropyl methyl cellulose, hydroxypropyl ethyl cellulose, salts of these, and the like.

In a case where the composition contains an aggregation control agent, the content of the aggregation control agent with respect to the total mass of the composition is preferably 0.1% to 20% by mass, and particularly preferably 0.5% to 10% by mass.

### (Anti-Aggregation Dispersant)

Examples of the dispersing resin include an anti-aggregation dispersant.

The anti-aggregation dispersant comprises a function of being adsorbed onto the surface of the magnetic particles so that the magnetic particles remain spaced apart from each other by at least a certain distance due to the interaction between the dispersants and that the magnetic particles are prevented from being directly aggregated with each other. As a result, the aggregation of the magnetic particles is suppressed, and even in a case where aggregates are formed, the density of the formed aggregates is relatively low. Furthermore, other components (for example, an alkali-soluble resin and the like) optionally added to the composition can be dispersed in the composition, and bulky aggregates can be formed. Therefore, redispersibility can be improved.

As the anti-aggregation dispersant, an alkylolammonium salt of a polybasic acid is preferable.

The polybasic acid may have two or more acid groups. Examples thereof include an acidic polymer containing a repeating unit having an acid group (for example, polyacrylic acid, polymethacrylic acid, polyvinylsulfonic acid, polyphosphoric acid, and the like). Examples of polybasic acids other than the above include a polymer obtained by polymerizing an unsaturated fatty acid such as crotonic acid. The alkylolammonium salt of a polybasic acid is obtained by reacting these polybasic acids with alkylolammonium. The salt obtained by such a reaction usually contains the following partial structure.

—C(═O)—N(—R¹)(—R²—OH)

Here, R¹ is an alkyl group, and R² is an alkylene group.

The alkylolammonium salt of a polybasic acid is preferably a polymer containing a plurality of partial structures described above. In a case where the alkylolammonium salt of a polybasic acid is a polymer, the weight-average molecular weight thereof is preferably 1,000 to 100,000, and more preferably 5,000 to 20,000. The polymer of the alkylolammonium salt of a polybasic acid is bonded to the surface of the magnetic particles and forms a hydrogen bond with molecules of other anti-aggregation dispersants, so that the main chain structure of the polymer goes in between the magnetic particles and the magnetic particles are spaced apart from each other.

Examples of one of the suitable aspects of the anti-aggregation dispersant include amide wax which is a condensate formed by dehydrocondensation of (a) saturated aliphatic monocarboxylic acids and hydroxy group-containing aliphatic monocarboxylic acids, (b) at least any acids among polybasic acids, and (c) at least any amines among diamines and tetramines.

It is preferable that aforementioned (a) to (c) be used so that (a):(b):(c)=1 to 3:0 to 5:1 to 6 in terms of molar ratio.

The saturated aliphatic monocarboxylic acids preferably have a carbon number of 12 to 22. Specific examples thereof include lauric acid, myristic acid, pentadecyl acid, palmitic acid, margaric acid, stearic acid, nonadecanoic acid, arachidic acid, behenic acid, and the like.

The hydroxy group-containing aliphatic monocarboxylic acids preferably have a carbon number of 12 to 22. Specific examples thereof include 12-hydroxystearic acid and dihydroxystearic acid.

Each of the saturated aliphatic monocarboxylic acids and each of the hydroxy group-containing aliphatic monocarboxylic acids may be used alone, or a plurality of saturated aliphatic monocarboxylic acids and a plurality of hydroxy group-containing aliphatic monocarboxylic acids may be used in combination.

The polybasic acids are preferably a carboxylic acid that has a carbon number of 2 to 12 and two or more replaceable hydrogen atoms, and more preferably a dicarboxylic acid.

Examples of such a dicarboxylic acid include an aliphatic dicarboxylic acid such as oxalic acid, malonic acid, succinic acid, glutaric acid, adipic acid, pimelic acid, suberic acid, azelaic acid, sebacic acid, 1,10-decanedicarboxylic acid, or 1,12-dodecanedicarboxylic acid; an aromatic dicarboxylic acid such as phthalic acid, isophthalic acid, or terephthalic acid; and an alicyclic dicarboxylic acid such as 1,2-cyclohexanedicarboxylic acid, 1,3-cyclohexanedicarboxylic acid, 1,4-cyclohexanedicarboxylic acid, or cyclohexylsuccinic acid. Each of these polybasic acids may be used alone, or a plurality of these polybasic acids may be used in combination.

The diamines preferably have a carbon number of 2 to 14. Specifically, examples thereof include ethylenediamine, 1,3-prop ane diamine, 1,4-butanediamine, hexamethylenediamine, metaxylylenediamine, tolylenediamine, paraxylylenediamine, phenylenediamine, isophoronediamine, 1,10-decanediamine, 1,12-dodecanediamine, 4,4-diaminodicyclohexylmethane, and 4,4-diaminodiphenylmethane.

The tetramines preferably have a carbon number of 2 to 14. Specific examples thereof include butane-1,1,4,4-tetramine and pyrimidine-2,4,5,6-tetramine. Each of the diamines and each of the tetramines may be used alone, or a plurality of diamines and a plurality of tetramines may be used in combination.

The amount of diamines and tetramines is adjusted depending on the number of moles of the saturated aliphatic monocarboxylic acids or the hydroxy group-containing aliphatic monocarboxylic acids and the number of moles of the polybasic acids, so that the total number of carboxy groups is equivalent to the total number of amino groups. For example, in a case where the number of moles of an aliphatic dicarboxylic acid, which is polybasic acids, is n (n=0 to 5) with respect to 2 moles of the aliphatic monocarboxylic acid, by setting the number of moles of diamines to (n+1), the amount of acids is equivalent to the amount of amines.

This amide wax is obtained as a mixture of a plurality of compounds having different molecular weights. The amide wax is preferably represented by the following Chemical Formula (I). The amide wax may be a single compound or a mixture.

A−C−(B−C)ₘ−A (I)

In formula (I), A is a dehydroxylated residue of a saturated aliphatic monocarboxylic acid and/or a hydroxy group-containing saturated aliphatic monocarboxylic acid, B is a dehydroxylated residue of a polybasic acid, C is a dehydrogenated residue of a diamine and/or a tetramine, and m satisfies 0≤m≤5.

Examples of one of the suitable aspects of the anti-aggregation dispersant include a compound represented by the following Formula (II).

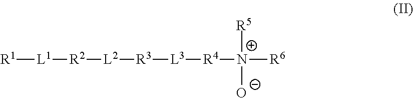

In Formula (II), R¹ represents a monovalent linear aliphatic hydrocarbon group with a carbon number of 10 to 25, R² and R³ each independently represent a divalent aliphatic hydrocarbon group with a carbon number of 2, 4, 6, or 8, a divalent alicyclic hydrocarbon group with a carbon number of 6, or a divalent aromatic hydrocarbon group, R⁴ represents a divalent aliphatic hydrocarbon group with a carbon number of 1 to 8, and R⁵ and R⁶ each independently represent a monovalent aliphatic hydrocarbon group with a carbon number of 1 to 3 or a hydroxyalkyl ether group.

In Formula (II), L¹ to L³ each independently represent an amide bond. In a case where L¹ and L³ each represent —CONH—, L² represents —NHCO—. In a case where L¹ and L³ each represent —NHCO—, L² represents —CONH—.

R¹ is a monovalent linear aliphatic hydrocarbon group with a carbon number of 10 to 25. Examples thereof include a linear alkyl group such as a decyl group, a lauryl group, a myristyl group, a pentadecyl group, a stearyl group, a palmityl group, a nonadecyl group, an eicosyl group, or a behenyl group; a linear alkenyl group such as a decenyl group, a pentadecenyl group, an oleyl group, or an eicosenyl group; and a linear alkynyl group such as a pentadecynyl group, an octadecynyl group, or a nonadecinyl group.

As R¹, among the above, a monovalent linear aliphatic hydrocarbon group with a carbon number of 14 to 25 is preferable, and a monovalent linear aliphatic hydrocarbon group with a carbon number of 18 to 21 is particularly preferable, because these have an excellent thickening effect and can suppress the occurrence of residual ash as much as possible even though the composition is baked at a low temperature. The linear aliphatic hydrocarbon group is preferably an alkyl group.

Examples of the divalent aliphatic hydrocarbon group with a carbon number of 2, 4, 6, or 8 represented by R² and R³ include an ethylene group, a n-butylene group, a n-hexylene group, and a n-octylene group.

Examples of the divalent alicyclic hydrocarbon group with a carbon number of 6 represented by R² and R³ include a 1,4-cyclohexylene group, a 1,3-cyclohexylene group, and a 1,2-cyclohexylene group.

Examples of the divalent aromatic hydrocarbon group represented by R² and R³ include an arylene group with a carbon number of 6 to 10, such as a 1,4-phenylene group, a 1,3-phenylene group, or a 1,2-phenylene group.

As R² and R³, among the above, in view of an excellent thickening effect, a divalent aliphatic hydrocarbon group with a carbon number of 2, 4, 6, or 8 is preferable, a divalent aliphatic hydrocarbon group with a carbon number of 2, 4, or 6 is more preferable, a divalent aliphatic hydrocarbon group with a carbon number of 2 or 4 is even more preferable, and a divalent aliphatic hydrocarbon group with a carbon number of 2 is particularly preferable. The divalent aliphatic hydrocarbon group is preferably a linear alkylene group.

R⁴ represents a divalent aliphatic hydrocarbon group with a carbon number of 1 to 8. Among these, in view of an excellent thickening effect, a linear or branched alkylene group is preferable, and a linear alkylene group is particularly preferable.

The divalent aliphatic hydrocarbon group represented by R⁴ has a carbon number of 1 to 8. In view of an excellent thickening effect, the carbon number is preferably 1 to 7, more preferably 3 to 7, even more preferably 3 to 6, and particularly preferably 3 to 5.

Therefore, R⁴ is preferably a linear or branched alkylene group with a carbon number of 1 to 8, more preferably a linear alkylene group with a carbon number of 1 to 7, even more preferably a linear alkylene group with a carbon number of 3 to 7, particularly preferably a linear alkylene group with a carbon number of 3 to 6, and most preferably a linear alkylene group with a carbon number of 3 to 5.

Examples of the monovalent aliphatic hydrocarbon group with a carbon number of 1 to 3 represented by R⁵ and R⁶ include a linear or branched alkyl group with a carbon number of 1 to 3 such as a methyl group, an ethyl group, a propyl group, or an isopropyl group; a linear or branched alkenyl group with a carbon number of 2 or 3 such as a vinyl group, a 1-methylvinyl group, or a 2-propenyl group; a linear or branched alkynyl group with a carbon number of 2 or 3 such as an ethynyl group or a propynyl group.

Examples of the hydroxyalkyl ether group represented by R⁵ and R⁶ include a mono or di(hydroxy) C₁₋₃ alkyl ether group such as a 2-hydroxyethoxy group, a 2-hydroxypropoxy group, or a 2,3-dihydroxypropoxy group.

Especially, R⁵ and R⁶ preferably each independently represent a monovalent aliphatic hydrocarbon group with a carbon number of 1 to 3, more preferably each independently represent a linear or branched alkyl group with a carbon number of 1 to 3, even more preferably each independently represent a linear alkyl group with a carbon number of 1 to 3, and particularly preferably each independently represent a methyl group.

As the compound represented by Formula (II), the compounds represented by the following Formulas (II-1) to (II-9) are preferable.

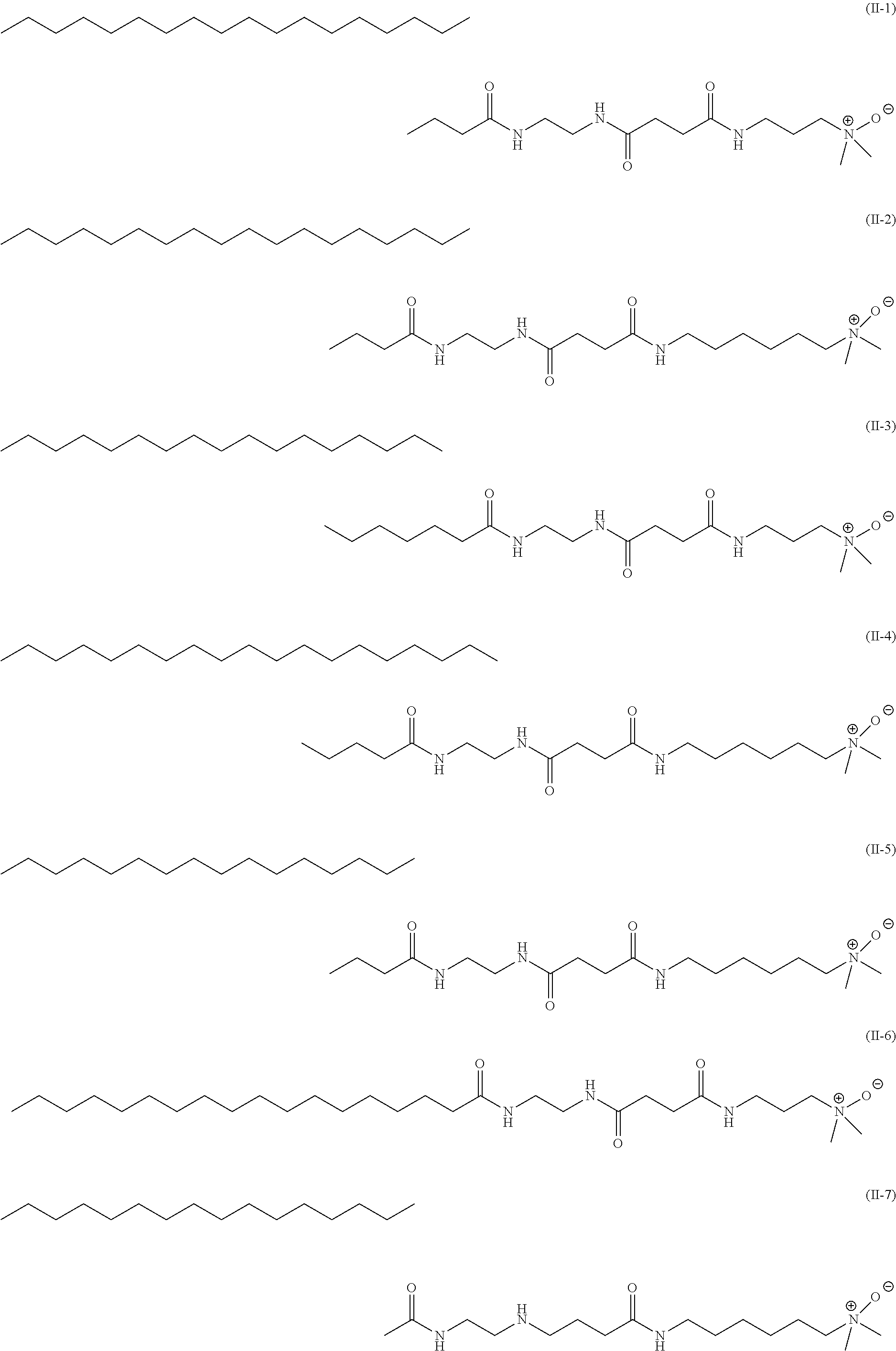

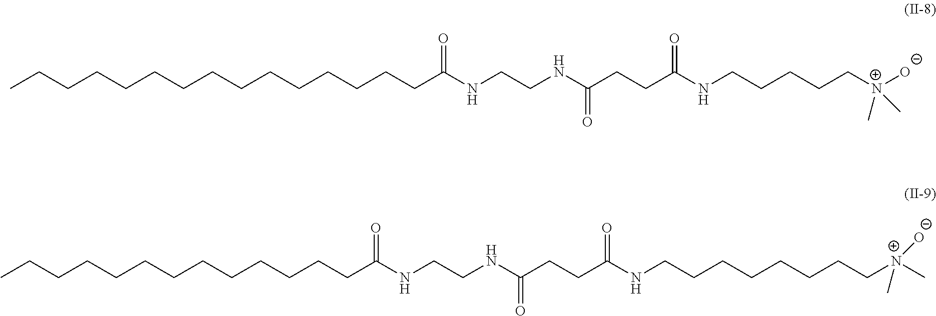 [SMILES: CCCCCCCCCCCCCCCC(=O)NCCNC(=O)CCC(=O)NCCCCC[N+](C)(C)[O-] ; CCCCCCCCCCCCCC(=O)NCCNC(=O)CCC(=O)NCCCCCCCC[N+](C)(C)[O-]]

Examples of the anti-aggregation dispersant include ANTI-TERRA-203, ANTI-TERRA-204, ANTI-TERRA-206, and ANTI-TERRA-250 (all are trade names, manufactured by BYK-Chemie GmbH.): ANTI-TERRA-U (trade name, manufactured by BYK-Chemie GmbH.): DISPER BYK-102, DISPER BYK-180, and DISPER BYK-191 (all are trade names, manufactured by BYK-Chemie GmbH.): BYK-P105″ (trade name, manufactured by BYK-Chemie GmbH.): TEGO Disper 630 and TEGO Disper 700 (all are trade names, manufactured by Evonik Degussa Japan Co., Ltd.): Taren VA-705B (trade name, manufactured by KYOEISHA CHEMICAL CO., LTD.): FLOWNON RCM-300TL (trade name, manufactured by KYOEISHA CHEMICAL CO., LTD., amide wax), and the like.

In a case where the composition contains an anti-aggregation dispersant, the content of the anti-aggregation dispersant with respect to the total mass of the composition is preferably 0.1% to 20% by mass, and particularly preferably 0.5% to 10% by mass.

### <Alkali-Soluble Resin>

The resin in the present invention may include an alkali-soluble resin. In the present specification, the alkali-soluble resin means a resin that contains a group (alkali-soluble group, for example, an acid group such as a carboxylic acid group) enhancing alkali solubility and is different from the resin A described above.

Examples of the alkali-soluble resin include a resin containing at least one alkali-soluble group in a molecule. Examples thereof include a polyhydroxystyrene resin, a polysiloxane resin, a (meth)acrylic resin, a (meth)acrylamide resin, a (meth)acrylic/(meth)acrylamide copolymer, an epoxy resin, a polyimide resin, and the like.

Specific examples of the alkali-soluble resin include a copolymer of an unsaturated carboxylic acid and an ethylenically unsaturated compound.

The unsaturated carboxylic acid is not particularly limited, and examples thereof include monocarboxylic acid such as (meth)acrylic acid, crotonic acid, and vinylacetic acid; dicarboxylic acids such as itaconic acid, maleic acid, and fumaric acid or anhydrides of these acids; polyvalent carboxylic acid monoesters such as mono(2-(meth)acryloyloxyethyl)phthalate; and the like.

Examples of copolymerizable ethylenically unsaturated compounds include methyl (meth)acrylate and the like. Furthermore, the compounds described in paragraphs 0027 of JP2010-97210A and paragraphs 0036 and 0037 of JP2015-68893A can also be used, and what are described in the above paragraphs are incorporated into the present specification.

Furthermore, a compound that is a copolymerizable ethylenically unsaturated compound and contains an ethylenically unsaturated group in a side chain may also be used in combination. That is, the alkali-soluble resin may contain a repeating unit containing an ethylenically unsaturated group in a side chain.

As the ethylenically unsaturated group contained in a side chain, a (meth)acrylic acid group is preferable.

The repeating unit containing an ethylenically unsaturated group in a side chain is obtained, for example, by causing an addition reaction between a carboxylic acid group of a (meth)acrylic repeating unit containing the carboxylic acid group and an ethylenically unsaturated compound containing a glycidyl group or an alicyclic epoxy group.

As the alkali-soluble resin, an alkali-soluble resin containing a curable group is also preferable.

Examples of the curable group include an ethylenically unsaturated group (for example, a (meth)acryloyl group, a vinyl group, a styryl group, or the like), a cyclic ether group (for example, an epoxy group, an oxetanyl group, or the like), and the like. However, the curable group is not limited to these.

As the curable group, among these, in view of making it possible to control polymerization by a radical reaction, an ethylenically unsaturated group is preferable, and a (meth)acryloyl group is more preferable.

As the alkali-soluble resin containing a curable group, an alkali-soluble resin having a curable group in a side chain or the like is preferable. Examples of the alkali-soluble resin containing a curable group include DIANAL NR series (manufactured by MITSUBISHI RAYON CO., LTD.), Photomer 6173 (COOH-containing polyurethane acrylic oligomer, manufactured by Diamond Shamrock Co., Ltd.), VISCOAT R-264 and KS Resist 106 (all are manufactured by OSAKA ORGANIC CHEMICAL INDUSTRY LTD.), CYCLOMER P series (for example, ACA230AA) and PLACCEL CF200 series (all are manufactured by DAICEL CORPORATION.), Ebecryl 3800 (manufactured by DAICEL-ALLNEX LTD.), and ACRYCURE RD-F8 (manufactured by NIPPON SHOKUBAI CO., LTD.), and the like.

As the alkali-soluble resin, for example, it is possible to use a radical polymer containing a carboxylic acid group in a side chain described in JP1984-44615A (JP-559-44615A), JP1979-34327B (JP-554-34327AB), JP1983-12577B (JP-558-12577B), JP1979-25957B (JP-554-25957B), JP1979-92723B (JP-554-92723B), JP1984-53836A (JP-559-53836A), and JP1984-71048A (JP-559-71048A); an acetal-modified polyvinyl alcohol-based binder resin containing an alkali-soluble group described in EP993966B, EP1204000B, and JP2001-318463A; polyvinylpyrrolidone; polyethylene oxide; alcohol-soluble nylon, polyether as a reactant of 2,2-bis-(4-hydroxyphenyl)-propane and epichlorohydrin, and the like; the polyimide resin described WO2008/123097A; and the like.

As the alkali-soluble resin, for example, the compounds described in paragraphs 0225 to 0245 of JP2016-75845A can also be used, and what are described in the above paragraphs are incorporated into the present specification.

As the alkali-soluble resin, a polyimide precursor can also be used. The polyimide precursor means a resin obtained by causing an addition polymerization reaction between a compound containing an acid anhydride group and a diamine compound at 40° C. to 100° C.

Specific examples of the polyimide precursor include the compounds described in paragraphs 0011 to 0031 of JP2008-106250A, the compounds described in paragraphs 0022 to 0039 of JP2016-122101A, the compounds described in paragraphs 0061 to 0092 of JP2016-68401A, the resins described in paragraph 0050 of JP2014-137523A, the resins described in paragraph 0058 of JP2015-187676A, the resins described in paragraphs 0012 and 0013 of JP2014-106326A, and the like. What are described in the above paragraphs are incorporated into the present specification.

As the alkali-soluble resin, a [benzyl (meth)acrylate/(meth)acrylic acid/other addition-polymerizable vinyl monomers used if necessary] copolymer and an [allyl(meth)acrylate/(meth)acrylic acid/other addition-polymerizable vinyl monomers used if necessary] copolymer are suitable because these make film hardness, sensitivity, and developability well balanced.

One kind of the aforementioned other addition-polymerizable vinyl monomers may be used alone, or two or more kinds of such monomers may be used in combination.

In view of further improving moisture resistance of a cured film, the aforementioned copolymers preferably have a curable group, and more preferably have an ethylenically unsaturated group such as a (meth)acryloyl group.

For example, monomers have a curable group may be used as the aforementioned other addition-polymerizable vinyl monomers so that the curable group is introduced into the copolymers. In addition, a curable group (preferably an ethylenically unsaturated group such as a (meth)acryloyl group) may be introduced into some or all of one or more kinds of units derived from (meth)acrylic acid and/or one or more kinds of units derived from the aforementioned other addition-polymerizable vinyl monomers in the copolymers.

Examples of the aforementioned other addition-polymerizable vinyl monomers include methyl (meth)acrylate, a styrene-based monomer (such as hydroxystyrene), and an ether dimer.

Examples of the ether dimer include a compound represented by the following General Formula (ED1) and a compound represented by the following General Formula (ED2).

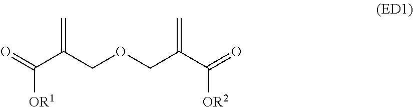

In General Formula (EDI), R¹ and R² each independently represent a hydrogen atom or a hydrocarbon group with a carbon number of 1 to 25.

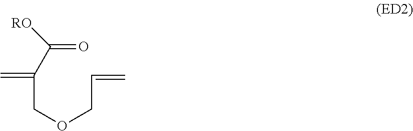

In General Formula (ED2), R represents a hydrogen atom or an organic group with a carbon number of 1 to 30. For specific examples of General Formula (ED2), the description of JP2010-168539A can be referred to.

For specific examples of the ether dimer, for example, paragraph 0317 of JP2013-29760A can be referred to, and what are described in the paragraph are incorporated into the present specification. Only one kind of ether dimer may be used alone, or two or more kinds of ether dimers may be used.

The acid value of the alkali-soluble resin is not particularly limited. Generally, the acid value is preferably 30 to 500 mgKOH/g, and more preferably 50 to 200 mgKOH/g or more.

In a case where the composition contains an alkali-soluble resin, the content of the alkali-soluble resin with respect to the total mass of the composition is preferably 0.1% to 40% by mass, more preferably 0.5% to 30% by mass, and particularly preferably 1% to 20% by mass.

### [Solvent]

The composition contains a solvent. Examples of the solvent include water and an organic solvent. As the solvent, an organic solvent is preferable.

In view of coating properties, the boiling point of the solvent is preferably 100° C. to 400° C., more preferably 150° C. to 300° C., and particularly preferably 170° C. to 250° C. In the present specification, unless otherwise specified, the boiling point means a standard boiling point.

Examples of the organic solvent include acetone, methyl ethyl ketone, cyclohexane, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetylacetone, cyclohexanone, cyclopentanone, diacetone alcohol, ethylene glycol monomethyl ether acetate, ethylene glycol ethyl ether acetate, ethylene glycol monoisopropyl ether, ethylene glycol monobutyl ether acetate, 1,4-butanedioldiacetate, 3-methoxypropanol, methoxy methoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethyl sulfoxide, γ-butyrolactone, butyl acetate, methyl lactate, N-methyl-2-pyrrolidone, ethyl lactate, and the like. However, the organic solvent is not limited to these.

In view of further improving the effects of the present invention, the content of the solvent with respect to the total mass of the composition is preferably 1% to 60% by mass, more preferably 2% to 50% by mass, and particularly preferably 3% to 40% by mass.

### [Polymerization Initiator]

The composition may contain a polymerization initiator.

As the polymerization initiator, known polymerization initiators can be used without particular limitation. Examples of the polymerization initiator include a photopolymerization initiator, a thermal polymerization initiator, and the like. Among these, a photopolymerization initiator is preferable. As the polymerization initiator, a so-called radical polymerization initiator is preferable.

The content of the polymerization initiator in the composition is not particularly limited. The content of the polymerization initiator with respect to the total solid content of the composition is preferably 0.5% to 15% by mass, more preferably 1.0% to 10% by mass, and even more preferably 1.5% to 8.0% by mass.

### <Thermal Polymerization Initiator>

Examples of the thermal polymerization initiator include azo compounds such as 2,2′-azobisisobutyronitrile (AIBN), 3-carboxypropionitrile, azobismalononitrile, and dimethyl-(2,2′)-azobis(2-methylpropionate) [V-601] and organic peroxides such as benzoyl peroxide, lauroyl peroxide, and potassium persulfate.

Specific examples of the polymerization initiator include the polymerization initiators described on pages 65 to 148 of “Ultraviolet Curing System” by Kiyomi Kato (published by GL Sciences Inc.: 1989), and the like.

### <Photopolymerization Initiator>

The photopolymerization initiator is not particularly limited as long as it can initiate the polymerization of the polymerizable compound. As the photopolymerization initiator, known photopolymerization initiators can be used. As the photopolymerization initiator, for example, a photopolymerization initiator sensitive to light ranging from an ultraviolet region to a visible light region is preferable. Furthermore, the photopolymerization initiator may be an activator that brings a certain action together with a photoexcited sensitizer and generates active radicals or an initiator that initiates cationic polymerization according to the type of polymerizable compound.

In addition, it is preferable that the photopolymerization initiator contain at least one kind of compound having molar absorption coefficient of at least 50 in a range of 300 to 800 nm (more preferably 330 to 500 nm).

Examples of the photopolymerization initiator include halogenated hydrocarbon derivatives (for example, a compound containing a triazine skeleton, a compound containing an oxadiazole skeleton, and the like), acylphosphine compounds such as acylphosphine oxide, hexaarylbiimidazole, oxime compounds such as oxime derivatives, organic peroxides, thio compounds, ketone compounds, aromatic onium salts, aminoacetophenone compounds, hydroxyacetophenone, and the like.

For specific examples of the photopolymerization initiator, for example, paragraphs 0265 to 0268 of JP2013-29760A can be referred to, and what are described in the paragraphs are incorporated into the present specification.

More specifically, as the photopolymerization initiator, for example, the aminoacetophenone-based initiator described in JP1998-291969A (JP-H10-291969A) and the acylphosphine-based initiator described in JP4225898B can also be used.

As hydroxyacetophenone compounds, for example, IRGACURE-184, DAROCUR-1173, IRGACURE-500, IRGACURE-2959, and IRGACURE-127 (trade names, all are manufactured by BASF SE) can be used.

As aminoacetophenone compounds, for example, commercially available products, IRGACURE-907, IRGACURE-369, and IRGACURE-379EG (trade names, all are manufactured by BASF SE), can be used. As aminoacetophenone compounds, it is also possible to use the compound described in JP2009-191179A having an absorption wavelength matched with a long wavelength light source having a wavelength of 365 nm or a wavelength of 405 nm.

As acylphosphine compounds, commercially available products, IRGACURE-819 and IRGACURE-TPO (trade names, all are manufactured by BASF SE), can be used.

As the photopolymerization initiator, an oxime ester-based polymerization initiator (oxime compound) is more preferable. Particularly, an oxime compound is preferable because this compound has high sensitivity and high polymerization efficiency and makes it easy to design a high coloring material content in the composition.

Specifically, as the oxime compound, for example, the compound described in JP2001-233842A, the compound described in JP2000-80068A, or the compound described in JP2006-342166A can be used.

Examples of the oxime compound include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-(4-toluenesulfonyloxy)iminobutan-2-one, 2-ethoxycarbonyloxyimino-1-phenylpropan-1-one, and the like.

Examples of the oxime compound also include the compounds described in J. C. S. Perkin II (1979) pp. 1653-1660, J. C. S. Perkin II (1979) pp. 156-162, Journal of Photopolymer Science and Technology (1995) pp. 202-232, and JP2000-66385A, the compounds described in JP2004-534797A, and the like.

As commercially available products, IRGACURE-OXE01 (manufactured by BASF SE), IRGACURE-OXE02 (manufactured by BASF SE), IRGACURE-OXE03 (manufactured by BASF SE), or IRGACURE-OXE04 (manufactured by BASF SE) is also preferable. In addition, TR-PBG-304 (manufactured by Changzhou Tronly New Electronic Materials Co., Ltd.), ADEKA ARKLS NCI-831 and ADEKA ARKLS NCI-930 (manufactured by ADEKA CORPORATION), or N-1919 (carbazole oxime ester skeleton-containing photoinitiator (manufactured by ADEKA CORPORATION)) can also be used.

Furthermore, as oxime compounds other than the above, the compound described in JP2009-519904A in which oxime is linked to the N-position of carbazole; the compound described in U.S. Pat. No. 7,626,957B in which a hetero substituent is introduced into a benzophenone moiety; the compounds described in JP2010-15025A and US2009-292039A in which a nitro group is introduced into a dye moiety; the ketoxime compound described in WO2009-131189A; the compound described in U.S. Pat. No. 7,556,910B that contains a triazine skeleton and an oxime skeleton in the same molecule; the compound described in JP2009-221114A that has absorption maximum at 405 nm and has excellent sensitivity to a g-line light source; and the like may also be used.

For example, paragraphs 0274 and 0275 of JP2013-29760A can be referred to, and what are described in the paragraphs are incorporated into the present specification.

Specifically, as the oxime compound, a compound represented by the following Formula (OX-1) is preferable. The aforementioned oxime compound may be an oxime compound in which the N—O bond is an (E) isomer, an oxime compound in which the N—O bond is a (Z) isomer, or an oxime compound in which the N—O bond is a mixture of an (E) isomer and a (Z) isomer.

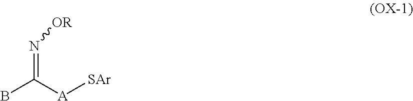

In Formula (OX-1), R and B each independently represent a monovalent substituent, A represents a divalent organic group, and Ar represents an aryl group.

In Formula (OX-1), as the monovalent substituent represented by R, a monovalent non-metal atomic group is preferable.

Examples of the monovalent non-metal atomic group include an alkyl group, an aryl group, an acyl group, an alkoxycarbonyl group, an aryloxycarbonyl group, a heterocyclic group, an alkylthiocarbonyl group, an arylthiocarbonyl group, and the like. Furthermore, these groups may have one or more substituents. In addition, the aforementioned substituents may be further substituted with another substituent.

Examples of the substituent include a halogen atom, an aryloxy group, an alkoxycarbonyl or aryloxycarbonyl group, an acyloxy group, an acyl group, an alkyl group, an aryl group, and the like.

As the monovalent substituent represented by B in Formula (OX-1), an aryl group, a heterocyclic group, an arylcarbonyl group, or a heterocyclic carbonyl group is preferable, and an aryl group or a heterocyclic group is more preferable. These groups may have one or more substituents. Examples of the substituents include the aforementioned substituents.

As the divalent organic group represented by A in Formula (OX-1), an alkylene group with a carbon number of 1 to 12, a cycloalkylene group, or an alkynylene group is preferable. These groups may have one or more substituents. Examples of the substituents include the aforementioned substituents.

As the photopolymerization initiator, an oxime compound containing a fluorine atom can also be used. Specific examples of the oxime compound containing a fluorine atom include the compounds described in JP2010-262028A; compounds 24 and 36 to 40 described in JP2014-500852A; the compound (C-3) described in JP2013-164471A; and the like. What are described in these documents are incorporated into the present specification.

As the photopolymerization initiator, compounds represented by the following General Formulas (1) to (4) can also be used.

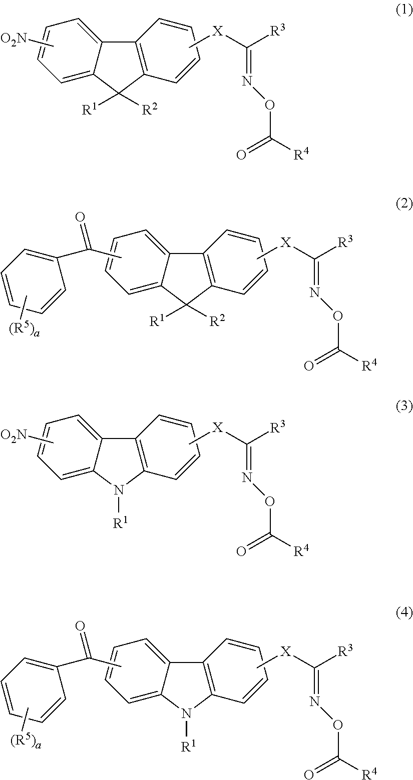

In Formula (1), R¹ and R² each independently represent an alkyl group with a carbon number of 1 to 20, an alicyclic hydrocarbon group with a carbon number of 4 to 20, an aryl group with a carbon number of 6 to 30, or an arylalkyl group with a carbon number of 7 to 30; in a case where R¹ and R² represent phenyl groups, the phenyl groups may be bonded together to form a fluorene group; R³ and R⁴ each independently represent a hydrogen atom, an alkyl group with a carbon number of 1 to 20, an aryl group with a carbon number of 6 to 30, an arylalkyl group with a carbon number of 7 to 30, or a heterocyclic group with a carbon number of 4 to 20; and X represents a direct bond or a carbonyl group.

In Formula (2), R¹, R², R³, and R⁴ have the same definitions as R¹, R², R³, and R⁴ in Formula (1), R⁵ represents —R⁶, —OR⁶, —SR⁶, —COR⁶, —CONR⁶R⁶, —NR⁶COR⁶, —OCOR⁶, —COOR⁶, —SCOR⁶, —OCSR⁶, —COSR⁶, —CSOR⁶, —CN, a halogen atom, or a hydroxyl group, R⁶ represents an alkyl group with a carbon number of 1 to 20, an aryl group with a carbon number of 6 to 30, an arylalkyl group with a carbon number of 7 to 30, or a heterocyclic group with a carbon number of 4 to 20, X represents a direct bond or a carbonyl group, and a represents an integer of 0 to 4.

In Formula (3), R¹ represents an alkyl group with a carbon number of 1 to 20, an alicyclic hydrocarbon group with a carbon number of 4 to 20, an aryl group with a carbon number of 6 to 30, or an arylalkyl group with a carbon number of 7 to 30; R³ and R⁴ each independently represent a hydrogen atom, an alkyl group with a carbon number of 1 to 20, an aryl group with a carbon number of 6 to 30, an arylalkyl group with a carbon number of 7 to 30, or a heterocyclic group with a carbon number of 4 to 20; and X represents a direct bond or a carbonyl group.

In Formula (4), R¹, R³, and R⁴ have the same definitions as R¹, R³, and R⁴ in Formula (3), R⁵ represents —R⁶, —OR⁶, —SR⁶, —COR⁶, —CONR⁶R⁶, —NR⁶COR⁶, —OCOR⁶, —COOR⁶, —SCOR⁶, —OCSR⁶, —COSR⁶, —CSOR⁶, —CN, a halogen atom, or a hydroxyl group, R⁶ represents an alkyl group with a carbon number of 1 to 20, an aryl group with a carbon number of 6 to 30, an arylalkyl group with a carbon number of 7 to 30, or a heterocyclic group with a carbon number of 4 to 20, X represents a direct bond or a carbonyl group, and a represents an integer of 0 to 4.

In the Formulas (1) and (2), each of R¹ and R² is preferably a methyl group, an ethyl group, an n-propyl group, an i-propyl group, a cyclohexyl group, or a phenyl group. R³ is preferably a methyl group, an ethyl group, a phenyl group, a tolyl group, or a xylyl group. R⁴ is preferably an alkyl group or a phenyl group with a carbon number of 1 to 6. R⁵ is preferably a methyl group, an ethyl group, a phenyl group, a tolyl group, or a naphthyl group. X is preferably a direct bond.

In the Formulas (3) and (4), R¹ is preferably a methyl group, an ethyl group, an n-propyl group, an i-propyl group, a cyclohexyl group, or a phenyl group. R³ is preferably a methyl group, an ethyl group, a phenyl group, a tolyl group, or a xylyl group. R⁴ is preferably an alkyl group with a carbon number of 1 to 6, or a phenyl group. R⁵ is preferably a methyl group, an ethyl group, a phenyl group, a tolyl group, or a naphthyl group. X is preferably a direct bond.

Specific examples of the compounds represented by Formulas (1) and (2) include the compounds described in paragraphs 0076 to 0079 of JP2014-137466A. What are described in these documents are incorporated into the present specification.

Specific examples of the oxime compound preferably used in the aforementioned composition will be shown below. Among the following oxime compounds, the oxime compound represented by General Formula (C-13) is more preferable.

Furthermore, as the oxime compound, the compounds described in Table 1 of WO2015/036910A can also be used, and what are described in the document are incorporated into the present specification.

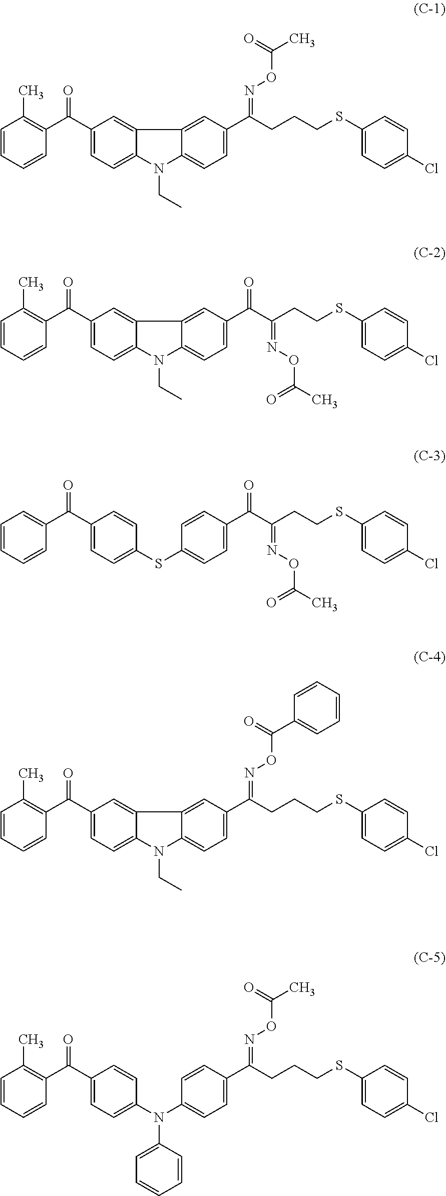 [SMILES: CCn1c2ccc(C(=O)c3ccccc3C)cc2c2cc(/C(CCCSc3ccc(Cl)cc3)=N/OC(C)=O)ccc21 ; CCn1c2ccc(C(=O)/C(CCSc3ccc(Cl)cc3)=N/OC(C)=O)cc2c2cc(C(=O)c3ccccc3C)ccc21 ; CC(=O)O/N=C(\CCSc1ccc(Cl)cc1)C(=O)c1ccc(Sc2ccc(C(=O)c3ccccc3)cc2)cc1 ; CCn1c2ccc(C(=O)c3ccccc3C)cc2c2cc(/C(CCCSc3ccc(Cl)cc3)=N/OC(=O)c3ccccc3)ccc21 ; CC(=O)O/N=C(\CCCSc1ccc(Cl)cc1)c1ccc(N(c2ccccc2)c2ccc(C(=O)c3ccccc3C)cc2)cc1]

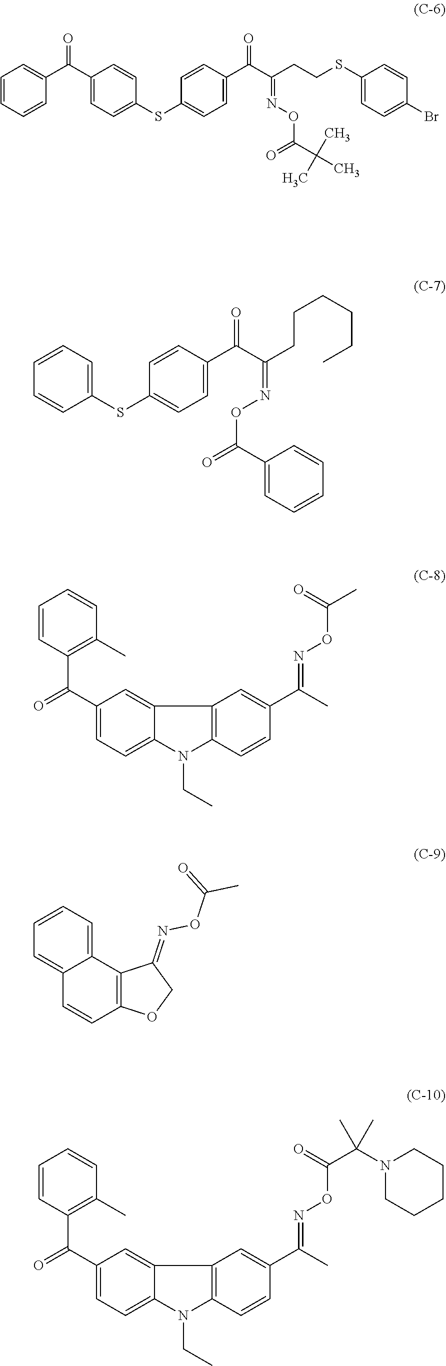 [SMILES: CC(C)(C)C(=O)O/N=C(\CCSc1ccc(Br)cc1)C(=O)c1ccc(Sc2ccc(C(=O)c3ccccc3)cc2)cc1 ; CCCCCC/C(=N/OC(=O)c1ccccc1)C(=O)c1ccc(Sc2ccccc2)cc1 ; CCn1c2ccc(C(=O)c3ccccc3C)cc2c2cc(/C(C)=N/OC(C)=O)ccc21 ; CC(=O)O/N=C1\COc2ccc3ccccc3c21 ; CCn1c2ccc(C(=O)c3ccccc3C)cc2c2cc(/C(C)=N/OC(=O)C(C)(C)N3CCCCC3)ccc21]

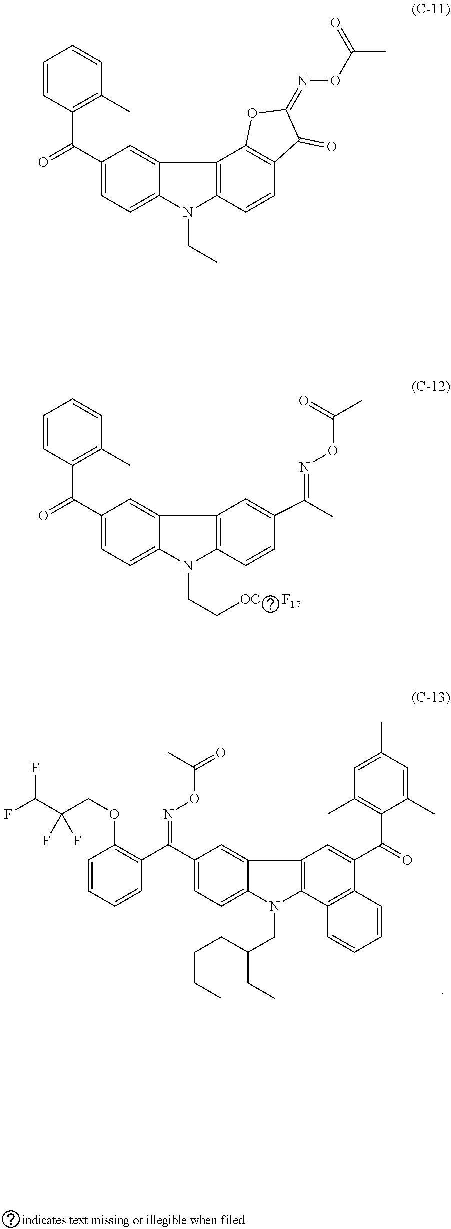

The oxime compound preferably has a maximum absorption wavelength in a wavelength range of 350 to 500 nm, more preferably has a maximum absorption wavelength in a wavelength range of 360 to 480 nm, and even more preferably has a high absorbance at wavelengths of 365 nm and 405 nm.

In view of sensitivity, the molar absorption coefficient of the oxime compound at 365 nm or 405 nm is preferably 1,000 to 300,000, more preferably 2,000 to 300,000, and even more preferably 5,000 to 200,000.

The molar absorption coefficient of a compound can be measured using known methods. For example, it is preferable to measure the molar absorption coefficient by using an ultraviolet-visible spectrophotometer (Cary-5 spectrophotometer manufactured by Varian) and ethyl acetate at a concentration of 0.01 g/L.

If necessary, two or more kinds of photopolymerization initiators may be used in combination.

As the photopolymerization initiator, it is also possible to use the compounds described in paragraph 0052 of JP2008-260927A, paragraphs 0033 to 0037 of JP2010-97210A, and paragraph 0044 of JP2015-68893A, and what are described in the paragraphs are incorporated into the present specification.

### [Polymerizable Compound]

The composition according to the aspect of the present invention may contain a polymerizable compound.

In the present specification, a polymerizable compound means a compound that is polymerized by the action of the aforementioned polymerization initiator, which is a component different from the aforementioned resin in the composition according to the aspect of the present invention.

The content of the polymerizable compound in the composition is not particularly limited. The content of the polymerizable compound with respect to the total solid content of the composition is preferably 1% to 25% by mass, more preferably 1% to 20% by mass, and even more preferably 3% to 15% by mass.

The molecular weight (or weight-average molecular weight) of the polymerizable compound is not particularly limited, but is preferably 2,000 or less.

As the polymerizable compound, a compound containing a group containing an ethylenically unsaturated bond (hereinafter, also simply called “ethylenically unsaturated group”) is preferable.

That is, it is preferable that the composition according to the embodiment of the present invention contain, as a polymerizable compound, a low-molecular-weight compound containing an ethylenically unsaturated group.

The polymerizable compound is preferably a compound containing one or more ethylenically unsaturated bonds, more preferably a compound containing two or more ethylenically unsaturated bonds, even more preferably a compound containing three or more ethylenically unsaturated bonds, and particularly preferably a compound containing five or more ethylenically unsaturated bonds. The upper limit of the number of ethylenically unsaturated bonds is, for example, 15 or less. Examples of the ethylenically unsaturated group include a vinyl group, a (meth)allyl group, a (meth)acryloyl group, and the like.

As the polymerizable compound, for example, it is possible to use the compounds described in paragraph 0050 of JP2008-260927A and paragraph 0040 of JP2015-68893A, and what are described in the paragraphs are incorporated into the present specification.

The polymerizable compound may be in any chemical form such as a monomer, a prepolymer, an oligomer, a mixture of these, and a multimer of these.

The polymerizable compound is preferably a (meth)acrylate compound having 3 to 15 functional groups, and more preferably a (meth)acrylate compound having 3 to 6 functional groups.

As the polymerizable compound, a compound that contains one or more ethylenically unsaturated groups and has a boiling point of 100° C. or higher under normal pressure is also preferable. For example, the compounds described in paragraph 0227 of JP2013-29760A and paragraph 0254 to 0257 of JP2008-292970A can be referred to, and what are described in the paragraphs are incorporated into the present specification.

As the polymerizable compound, dipentaerythritol triacrylate (KAYARAD D-330 as a commercially available product; manufactured by Nippon Kayaku Co., Ltd.), dipentaerythritol tetraacrylate (KAYARAD D-320 as a commercially available product; manufactured by Nippon Kayaku Co., Ltd.), dipentaerythritol penta(meth)acrylate (KAYARAD D-310 as a commercially available product; manufactured by Nippon Kayaku Co., Ltd.), dipentaerythritol hexa(meth)acrylate (KAYARAD DPHA as a commercially available product; manufactured by Nippon Kayaku Co., Ltd., A-DPH-12E; manufactured by SHIN-NAKAMURA CHEMICAL CO, LTD.), and a structure in which these, and the structure in which these (meth)acryloyl groups are mediated by an ethylene glycol residue or a propylene glycol residue (for example, SR454 and SR499 commercially available from Sartomer Company Inc.) are preferable. These compounds in oligomer types can also be used. Furthermore, NK ESTER A-TMMT (pentaerythritol tetraacrylate, manufactured by SHIN-NAKAMURA CHEMICAL CO, LTD.), KAYARAD RP-1040, KAYARAD DPEA-12LT, KAYARAD DPHA LT, KAYARAD RP-3060, and KAYARAD DPEA-12 (all are trade names, manufactured by Nippon Kayaku Co., Ltd.), and the like may also be used.

Aspects of preferable polymerizable compounds will be shown below.

The polymerizable compound may have an acid group such as a carboxylic acid group, a sulfonic acid group, or a phosphoric acid group. The polymerizable compound containing an acid group is preferably an ester of an aliphatic polyhydroxy compound and an unsaturated carboxylic acid, more preferably a polymerizable compound obtained by reacting an unreacted hydroxyl group of an aliphatic polyhydroxy compound with a non-aromatic carboxylic anhydride so that an acid group is added, and even more preferably an ester of the aforementioned polymerizable compound having pentaerythritol and/or dipentaerythritol as the aliphatic polyhydroxy compound. Examples of commercially available products thereof include ARONIX TO-2349, M-305, M-510, and M-520 manufactured by TOAGOSEI CO., LTD., and the like.

The acid value of the polymerizable compound containing an acid group is preferably 0.1 to 40 mgKOH/g, and more preferably 5 to 30 mgKOH/g. In a case where the acid value of the polymerizable compound is 0.1 mgKOH/g or more, development and dissolution characteristics are excellent. In case where the acid value is 40 mgKOH/g or less, this is advantageous in terms of manufacturing and/or handling. Furthermore, excellent photopolymerization performance and excellent curing properties are obtained.

As the polymerizable compound, a compound containing a caprolactone structure is also a preferable aspect.

The compound containing a caprolactone structure is not particularly limited as long as the compound contains the caprolactone structure in a molecule. Examples thereof include ϵ-caprolactone-modified polyfunctional (meth)acrylate obtained by esterifying a polyhydric alcohol, such as trimethylolethane, ditrimethylolethane, trimethylolpropane, ditrimethylolpropane, pentaerythritol, dipentaerythritol, tripentaerythritol, glycerin, diglycerol, or trimethylol melamine, (meth)acrylic acid, and c-caprolactone. Among these, a compound containing a caprolactone structure represented by the following Formula (Z-1) is preferable.

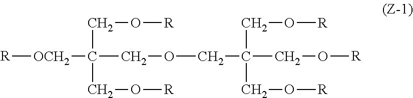

In Formula (Z-1), all six Rs are groups represented by the following Formula (Z-2), or one to five out of six Rs are groups represented by the following Formula (Z-2) and others are groups represented by the following Formula (Z-3).

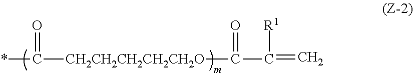

In Formula (Z-2), R¹ represents a hydrogen atom or a methyl group, m represents a number of 1 or 2, and “*” represents a bond.

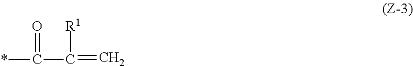

In Formula (Z-3), R¹ represents a hydrogen atom or a methyl group, and “*” represents a bond.

The polymerizable compound containing a caprolactone structure is commercially available from Nippon Kayaku Co., Ltd., for example, as KAYARAD DPCA series. Examples thereof include DPCA-20 (compound where m in the above Formulas (Z-1) to (Z-3) is 1, the number of groups represented by Formula (Z-2) is 2, and R¹'s all represent a hydrogen atom), DPCA-30 (compound where m in the above Formulas (Z-1) to (Z-3) is 1, the number of groups represented by Formula (Z-2) is 3, and R¹'s all represent a hydrogen atom), DPCA-60 (compound where m in the above Formulas (Z-1) to (Z-3) is 1, the number of groups represented by Formula (Z-2) is 6, and R¹'s all represent a hydrogen atom), DPCA-120 (compound where m in the above Formulas (Z-1) to (Z-3) is 2, the number of groups represented by Formula (Z-2) is 6, and R¹'s all represent a hydrogen atom), and the like. Furthermore, examples of commercially available products of the polymerizable compound containing a caprolactone structure include M-350 (trade name) (trimethylolpropane triacrylate) manufactured by TOAGOSEI CO., LTD.

As the polymerizable compound, a compound represented by the following Formula (Z-4) or (Z-5) can also be used.

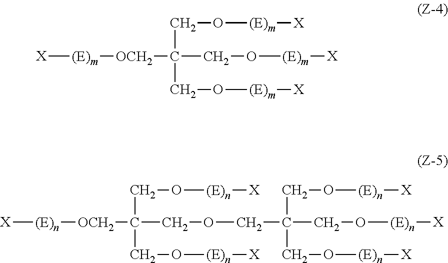

In Formulas (Z-4) and (Z-5), E represents —((CH₂)_{y}CH₂O)— or ((CH₂)_{y}CH(CH₃)O)—, y represents an integer of 0 to 10, and X represents a (meth)acryloyl group, a hydrogen atom, or a carboxylic acid group.

In Formula (Z-4), the total number of (meth)acryloyl groups is 3 or 4, m represents an integer of 0 to 10, and the total of m's is an integer of 0 to 40.

In Formula (Z-5), the total number of (meth)acryloyl groups is 5 or 6, n represents an integer of 0 to 10, and the total of n's is an integer of 0 to 60.

In Formula (Z-4), m is preferably an integer of 0 to 6, and more preferably an integer of 0 to 4.

The total of m's is preferably an integer of 2 to 40, more preferably an integer of 2 to 16, and even more preferably an integer of 4 to 8.

In Formula (Z-5), n is preferably an integer of 0 to 6, and more preferably an integer of 0 to 4.

The total of n's is preferably an integer of 3 to 60, more preferably an integer of 3 to 24, and even more preferably an integer of 6 to 12.

In addition, as for —((CH₂)_{y}CH₂O)— or ((CH₂)_{y}CH(CH₃)O)— in Formula (Z-4) or Formula (Z-5), it is preferable that the terminal on the oxygen atom side be bonded to X.

One kind of compound represented by Formula (Z-4) or Formula (Z-5) may be used alone, or two or more kinds of such compounds may be used in combination. Especially, it is preferable to employ an aspect in which all of six Xs in Formula (Z-5) represent an acryloyl group or an aspect in which a compound represented by Formula (Z-5) where all of six Xs represent an acryloyl group and a compound represented by Formula (Z-5) where at least one of six Xs represents a hydrogen atom form a mixture. This configuration can further improve developability.

The total content of the compound represented by Formula (Z-4) or Formula (Z-5) in the polymerizable compound is preferably 20% by mass or more, and more preferably 50% by mass or more.

Among the compounds represented by Formula (Z-4) or Formula (Z-5), either or both of a pentaerythritol derivative and a dipentaerythritol derivative are more preferable.

The polymerizable compound may contain a cardo skeleton.

As the polymerizable compound containing a cardo skeleton, a polymerizable compound containing a 9,9-bisarylfluorene skeleton is preferable.

Examples of the polymerizable compound containing a cardo skeleton include, but are not limited to, ONCOAT EX series (manufactured by NAGASE & CO., LTD.), OGSOL (manufactured by Osaka Gas Chemicals Co., Ltd.), and the like.

As the polymerizable compound, a compound containing an isocyanuric acid skeleton as a core is also preferable. Examples of such a polymerizable compound include NK ESTER A-9300 (manufactured by SHIN-NAKAMURA CHEMICAL CO, LTD.).

The content of ethylenically unsaturated groups in the polymerizable compound (the content means a value obtained by dividing the number of ethylenically unsaturated groups in the polymerizable compound by the molecular weight (g/mol) of the polymerizable compound) is preferably 5.0 mmol/g or more. The upper limit of the content is not particularly limited, but is generally 20.0 mmol/g or less.

As the polymerizable compound, an oxacyclo compound is also preferably used. As the oxacyclo compound, a compound having an epoxy group or an oxetanyl group is preferable, and a compound having an epoxy group (epoxy compound) is particularly preferable.

Specific examples of such a polymerizable compound include a monofunctional or polyfunctional glycidyl ether compound.

Examples of commercially available products thereof include polyfunctional aliphatic glycidyl ether compounds such as DENACOL EX-212L, EX-214L, EX-216L, EX-321L, and EX-850L (all are manufactured by Nagase ChemteX Corporation.). Although these are low-chlorine products, EX-212, EX-214, EX-216, EX-321, EX-614, EX-850, and the like that are not low-chlorine products can also be used.

Furthermore, as a commercially available product, CELLOXIDE 2021P (manufactured by DAICEL CORPORATION., a polyfunctional epoxy monomer) can also be used.

### [Polymerization Inhibitor]

The composition may contain a polymerization inhibitor.

As the polymerization inhibitor, known polymerization inhibitors can be used without particular limitation. Examples of the polymerization inhibitor include a phenol-based polymerization inhibitor (for example, p-methoxyphenol, 2,5-di-tert-butyl-4-methylphenol, 2,6-di-tert-butyl-4-methylphenol, 4,4′-thiobis(3-methyl-6-t-butylphenol), 2,2′-methylenebis(4-methyl-6-t-butylphenol), 4-methoxynaphthol, or the like); a hydroquinone-based polymerization inhibitor (for example, hydroquinone, 2,6-di-tert-butyl hydroquinone, or the like); a quinone-based polymerization inhibitor (for example, benzoquinone or the like); a free radical-based polymerization inhibitor (for example, a 2,2,6,6-tetramethylpiperidine 1-oxyl free radical, a 4-hydroxy-2,2,6,6-tetramethylpiperidine 1-oxyl free radical, or the like); a nitrobenzene-based polymerization inhibitor (for example, nitrobenzene, 4-nitrotoluene, or the like); a phenothiazine-based polymerization inhibitor (for example, phenothiazine, 2-methoxyphenothiazine, or the like); and the like.

Among these, a phenol-based polymerization inhibitor or a free radical-based polymerization inhibitor is preferable.

The effect of the polymerization inhibitor is marked in a case where the polymerization inhibitor is used together with a resin containing a curable group.

The content of the polymerization inhibitor in the composition is not particularly limited. The content of the polymerization inhibitor with respect to the total solid content of the composition is preferably 0.0001% to 0.5% by mass, more preferably 0.0001% to 0.2% by mass, and even more preferably 0.0001% to 0.05% by mass.

The ratio of the content of the polymerization inhibitor to the content of the polymerizable compound in the composition (content of polymerization inhibitor/content of polymerizable compound (mass ratio)) is preferably more than 0.0005, more preferably 0.0006 to 0.02, and even more preferably 0.0006 to 0.005.

### [Surfactant]

The composition may contain a surfactant. The surfactant contributes to the improvement of the coating properties of the composition.

In a case where the composition contains a surfactant, the content of the surfactant with respect to the total solid content of the composition is preferably 0.001% to 2.0% by mass, more preferably 0.005% to 0.5% by mass, and even more preferably 0.01% to 0.1% by mass.

Examples of the surfactant include a fluorine-based surfactant, a nonionic surfactant, a cationic surfactant, an anionic surfactant, a silicone-based surfactant, and the like.

For example, in a case where the composition contains a fluorine-based surfactant, the liquid properties (particularly, fluidity) of the composition are further improved. That is, in a case where a film is formed using the composition containing a fluorine-based surfactant, the interfacial tension between the surface to be coated and the coating liquid is reduced, and the wettability with respect to the surface to be coated is improved, which improves the coating properties with respect to the surface to be coated. Therefore, it is effective to use the composition containing a fluorine-based surfactant, because then a film having a uniform thickness with small thickness unevenness is more suitably formed even in a case where a thin film of about several μm is formed using a small amount of liquid.

The fluorine content in the fluorine-based surfactant is preferably 3% to 40% by mass, more preferably 5% to 30% by mass, and even more preferably 7% to 25% by mass. The fluorine-based surfactant with a fluorine content in this range is effective for achieving thickness uniformity of a coating film and/or saving liquid, and has excellent solubility in the composition.

Examples of the fluorine-based surfactant include MEGAFACE F171, MEGAFACE F172, MEGAFACE F173, MEGAFACE F176, MEGAFACE F177, MEGAFACE F141, MEGAFACE F142, MEGAFACE F143, MEGAFACE F144, MEGAFACE R30, MEGAFACE F437, MEGAFACE F475, MEGAFACE F479, MEGAFACE F482, MEGAFACE F554, and MEGAFACE F780 (all are manufactured by DIC Corporation); FLUORAD FC430, FLUORAD FC431, and FLUORAD FC171 (all are manufactured by Sumitomo 3M Limited.), SURFLON S-382, SURFLON SC-101, SURFLON SC-103, SURFLON SC-104, SURFLON SC-105, SURFLON SC-1068, SURFLON SC-381, SURFLON SC-383, SURFLON S-393, and SURFLON KH-40 (manufactured by AGC Inc.), PF636, PF656, PF6320, PF6520, and PF7002 (manufactured by OMNOVA Solutions Inc.), and the like.

A block polymer can also be used as the fluorine-based surfactant, and specific examples thereof include the compounds described in JP2011-89090A.

### [Other Optional Components]

The composition may further contain other optional components in addition to the aforementioned components. Examples thereof include a sensitizer, a co-sensitizer, a crosslinking agent (curing agent), a curing accelerator, a thermosetting accelerator, a plasticizer, a diluent, an oil sensitizing agent, a rubber component, and the like. If necessary, known additives, such as an adhesion facilitator and other aids (for example, an antifoaming agent, a flame retardant, a leveling agent, a peeling accelerator, an antioxidant, a fragrance, a surface tension adjuster, a chain transfer agent, and the like) may be further added to a substrate surface.

### [Physical Properties of Composition]

In view of further improving sedimentation stability of the magnetic particles, the viscosity of the composition at 23° C. and a shear rate of 0.1 (1/s) is preferably 1 to 10,000 Pa·s, more preferably 10 to 5,000 Pa·s, and particularly preferably 50 to 1,000 Pa·s.

In view of further improving sedimentation stability of the magnetic particles, the viscosity of the composition at 23° C. and a shear rate of 1,000 (1/s) is preferably 100 Pa·s or less, more preferably 50 Pa·s or less, and particularly preferably 10 Pa·s or less. The lower limit of the viscosity at a shear rate of 1,000 (1/s) is preferably 0.001 Pa·s or more.

The viscosity of the composition at 23° C. is obtained by measuring viscosity at 23° C. by using MCR-102 (manufactured by Anton Paar GmbH) while increasing the shear rate from 0.1/s to 1,000/s.

### [Manufacturing Method of Composition]

The composition can be prepared by mixing together the components described above by a known mixing method (for example, a mixing method using a stirrer, a homogenizer, a high-pressure emulsifier, a wet pulverizer, a wet disperser, or the like).

In preparing the composition according to the aspect of the present invention, the components may be mixed together at once, or the components may be dissolved or dispersed one by one in a solvent and then sequentially mixed together. Furthermore, the order of adding components and working conditions at the time of mixing are not particularly limited.

### [Magnetic Particle-Containing Film]

The magnetic particle-containing film according to an embodiment of the present invention is formed of the aforementioned magnetic particle-containing composition according to the embodiment of the present invention.

In view of further improving magnetic permeability, the film thickness of the magnetic particle-containing film is preferably 1 to 10,000 μm, more preferably 10 to 1,000 μm, and particularly preferably 15 to 800 μm.

The magnetic particle-containing film is suitably used as electronic components such as an antenna and an inductor installed in an electronic communication device and the like.

### [Manufacturing Method of Magnetic Particle-Containing Film]

The magnetic particle-containing film according to the embodiment of the present invention is obtained, for example, by curing the aforementioned composition.

The manufacturing method of the magnetic particle-containing film is not particularly limited, but preferably includes the following steps.

### Composition Layer Forming Step

### Curing Step

### <Composition Layer Forming Step>

In the composition layer forming step, the magnetic particle-containing composition is applied to a substrate (support) or the like so that a layer of the magnetic particle-containing composition (composition layer) is formed. As the substrate, for example, a wiring board having an antenna portion or an inductor portion and the like can be used.

As a method for applying the magnetic particle-containing composition to the substrate, various coating methods such as a slit coating method, an inkjet method, a spin coating method, a cast coating method, a roll coating method, and a screen printing method can be used. The film thickness of the composition layer is preferably 1 to 10,000 μm, more preferably 10 to 1,000 μm, and particularly preferably 15 to 800 μm. The composition layer applied to the substrate is dried (prebaked), for example, using a hot plate, an oven, or the like at a temperature of 50° C. to 140° C. for 10 to 1,800 seconds.

### <Curing Step>

The curing step is not particularly limited as long as the composition layer can be cured, and examples thereof include a heating treatment of heating the composition layer, an exposure treatment of irradiating the composition layer with an actinic ray or radiation, and the like.

In a case where the heating treatment is performed, for example, the heating treatment can be performed continuously or in batch by using heating means such as a hot plate, a convection oven (hot air circulation-type dryer), or a high-frequency heater.

The heating temperature during the heating treatment is preferably 120° C. to 260° C., and particularly preferably 150° C. to 240° C.

Note that prebaking in the composition layer forming step may serve as the heating treatment in the curing step.

In a case where the exposure treatment is performed, the method of irradiating the composition layer with an actinic ray or radiation is not particularly limited. It is preferable to irradiate the composition layer through a photomask having a patterned opening portion.

The exposure is preferably performed by irradiation with radiation. As the radiation that can be used for exposure, an ultraviolet ray such as g-line, h-line, or i-line is preferable, and a high-pressure mercury lamp is preferable as a light source. The irradiation intensity is preferably 5 to 1,500 mJ/cm², and more preferably 10 to 1,000 mJ/cm².

In a case where the magnetic particle-containing composition contains a thermal polymerization initiator, the composition layer may be heated in the above exposure treatment. The heating temperature is not particularly limited, but is preferably 80° C. to 250° C. The heating time is not particularly limited, but is preferably 30 to 300 seconds.

In a case where the composition layer is heated in the exposure treatment, the heating may serve as a post-heating step which will be described later. In other words, in a case where the composition layer is heated in the exposure treatment, the manufacturing method of the magnetic particle-containing film may not include a post-heating step.

### <Development Step>

In a case where the exposure treatment is performed in the curing step, the manufacturing method may further include a development step.

The development step is a step of developing the exposed composition layer so as to form a magnetic particle-containing film. By this step, the composition layer in a portion not being irradiated with light in the exposure treatment is eluted, and only the photo-cured portion remains. In this way, a patterned magnetic particle-containing film is obtained.

Although the type of developer used in the development step is not particularly limited, it is desirable to use an alkali developer that does not damage the circuit or the like.

The development temperature is, for example, 20° C. to 30° C.

The development time is, for example, 20 to 90 seconds. In recent years, in order to more thoroughly remove residues, sometimes the development has been performed for 120 to 180 seconds. Furthermore, in order to further improve the residue removability, sometimes a step of shaking off the developer every 60 seconds and supplying a new developer is repeated several times.

As the alkali developer, an alkaline aqueous solution is preferable which is prepared by dissolving an alkaline compound in water at a concentration of 0.001% to 10% by mass (preferably 0.01% to 5% by mass).

Examples of the alkaline compound include sodium hydroxide, potassium hydroxide, sodium carbonate, sodium silicate, sodium metasilicate, aqueous ammonia, ethylamine, diethylamine, dimethylethanolamine, tetramethylammonium hydroxide, tetraethylammonium hydroxide, tetrapropylammonium hydroxide, tetrabutylammonium hydroxide, benzyltrimethylammonium hydroxide, choline, pyrrole, piperidine, 1,8-diazabicyclo [5.4.0]-7-undecene, and the like (among these, an organic alkali is preferable).

In a case where an alkali developer is used, generally, a rinsing treatment using water is performed after development.

### <Post-Baking>

In a case where the exposure treatment is performed in the curing step, it is preferable to perform the heating treatment (post-baking) after the curing step. The post-baking is a post-development heating treatment for completion of curing. The heating temperature is preferably 240° C. or lower, and more preferably 220° C. or lower. The lower limit of the heating temperature is not particularly limited. However, considering an efficient and effective treatment, the heating temperature is preferably 50° C. or higher, and more preferably 100° C. or higher.

The post-baking can be performed continuously or in batch by using heating means such as a hot plate, a convection oven (hot air circulation-type dryer), or a high-frequency heater.

It is preferable that the aforementioned post-baking be performed in an atmosphere with a low oxygen concentration. The oxygen concentration is preferably 19% by volume or less, more preferably 15% by volume or less, even more preferably 10% by volume or less, particularly preferably 7% by volume or less, and most preferably 3% by volume or less. The lower limit of the oxygen concentration is not particularly limited, but is practically 10 ppm by volume or more.

Instead of post-baking by heating described above, ultraviolet (UV) irradiation may be performed to complete curing.

In this case, it is preferable that the magnetic particle-containing composition further contain a UV curing agent. The UV curing agent is preferably a UV curing agent that can be cured at a wavelength shorter than 365 nm, which is the exposure wavelength of the polymerization initiator added for the lithography process by ordinary i-line exposure. Examples of the UV curing agent include Omnirad 2959 (trade name) (manufactured by IGM Resins B. V.). In a case where UV irradiation is performed, it is preferable that the composition layer be a material that is cured at a wavelength of 340 nm or less. The lower limit of the wavelength is not particularly limited, but is 220 nm or more in general. The exposure amount of UV irradiation is preferably 100 to 5,000 mJ, more preferably 300 to 4,000 mJ, and even more preferably 800 to 3,500 mJ. In order to more effectively cure the composition layer at a low temperature, it is preferable that this UV curing step be performed after the exposure treatment. As the exposure light source, it is preferable to use an ozoneless mercury lamp.

### [Electronic Component]

The electronic component according to an embodiment of the present invention includes the aforementioned magnetic particle-containing film according to the embodiment of the present invention. That is, the electronic component according to the embodiment of the present invention may include the magnetic particle-containing film as a part of the component. Examples of electronic component include an inductor and an antenna. As the electronic component, an electronic component having a known structure can be used.

### Examples

Hereinafter, the present invention will be more specifically described based on examples. The materials, amounts and proportions of the materials used, details and procedures of treatments, and the like described in the following examples can be appropriately changed as long as the gist of the present invention is maintained. Therefore, the scope of the present invention is not limited to the following specific examples.

### [Various Components Used for Preparing Magnetic Particle-Containing Composition]

To make the magnetic particle-containing composition, the components described in Table 1 were prepared. The components described in Table 1 are summarized below.

### [Magnetic Particles]

M-1: Fe-based amorphous particles (trade name “AW2-08 PF-5F”, manufactured by Epson Atmix Corporation, average primary particle diameter 3 μm)

M-2: Fe-based amorphous particles (trade name “AW2-08 PF-8F”, manufactured by Epson Atmix Corporation, average primary particle diameter 5 μm)

M-3: Fe—Si—Cr-based alloy particles (trade name “MA-XCQ-4”, manufactured by DOWA ELECTRONICS MATERIALS CO., LTD., average primary particle diameter 3 μm)

M-4: Fe—Si—Cr-based alloy particles (trade name “MA-XCQ-5”, manufactured by DOWA ELECTRONICS MATERIALS CO., LTD., average primary particle diameter 5 μm)

M-5: Fe-based amorphous particles (trade name “KUAMET6B2-V1-38 μm”, manufactured by Epson Atmix Corporation, average primary particle diameter 15 μm)

M-6: Fe-based amorphous particles (trade name “KUAMET6B2-53 μm”, manufactured by Epson Atmix Corporation, average primary particle diameter 24 μm)

M-7: Fe-based amorphous particles (trade name “KUAMET6B2-150 μm”, manufactured by Epson Atmix Corporation, average primary particle diameter 50 μm)

M-8: Co-based amorphous particles (trade name “KUAMET-CT5-25 μm”, manufactured by Epson Atmix Corporation, average primary particle diameter 25 μm)

M-9: Co-based amorphous particles (trade name “KUAMET-CT5-5 μm”, manufactured by Epson Atmix Corporation, average primary particle diameter 5 μm)

M-10: Supermalloy particles (trade name “80% NI-4MO WA13”, manufactured by Epson Atmix Corporation, average primary particle diameter 15 μm)

M-11: Supermalloy particles (trade name “80% NI-4MO PF-15F”, manufactured by Epson Atmix Corporation, average primary particle diameter 8 μm)

M-12: Supermalloy particles (trade name “80% NI-4MO PF-5F”, manufactured by Epson Atmix Corporation, average primary particle diameter 4 μm)

M-13: Ni—Zn-based ferrite particles (trade name “BSN-125”, manufactured by TODA KOGYO CORP., average primary particle diameter 5 μm)

M-14: Mn—Zn-based ferrite particles (trade name “BSF-547”, manufactured by TODA KOGYO CORP., average primary particle diameter 11 μm)

M-15: Ni—Zn-based ferrite particles (trade name “NB4”, manufactured by Japan Metals & Chemicals Co., Ltd., average primary particle diameter 3 μm)

M-16: magnetoplumbite-type hexagonal ferrite particles (SrFe_{(9.58)}Al_{(2.42)}O₁₉, manufactured by the same method as the method described in Example 1 in WO2019/131675A, single-layered crystal phase, average primary particle diameter 0.1 μm)

M-17: magnetoplumbite-type hexagonal ferrite particles (SrFe_{(9.58)}Al_{(2.42)}O₁₉, manufactured by the same method as the method described in Example 1 in WO2019/131675A, single-layered crystal phase, average primary particle diameter 5 μm)

M-18: magnetoplumbite-type hexagonal ferrite particles (SrFe_{(9.58})Al_{(2.42)}O₁₉, manufactured by the same method as the method described in Example 1 in WO2019/131675A, single-layered crystal phase, average primary particle diameter 15 μm)

The average primary particle diameter of the magnetic particles is a value measured by the method described above.

### [Resin (Dispersant)]

D-1: the following compound (weight-average molecular weight 10,000, amine value 50 mgKOH/g, acid value 50 mgKOH/g, solubility in solvent S-1 300 g/L, solubility in solvent S-2 300 g/L)

D-2: the following compound (weight-average molecular weight 10,000, solubility in solvent S-1 300 g/L, solubility in solvent S-2 300 g/L, acid value 70 mgKOH/g)

D-3: the following compound (weight-average molecular weight 10,000, acid value 40 mgKOH/g, solubility in solvent S-1 400 g/L, solubility in solvent S-2 400 g/L)

D-4: trade name “BYK-P105” (manufactured by BYK-Chemie GmbH.), polymer of low-molecular-weight unsaturated carboxylic acid, acid value 365 mgKOH/g, solubility in solvent S-1 500 g/L, solubility in solvent S-2 500 g/L

D-5: trade name “ANTI-TERRA-204” (manufactured by BYK-Chemie GmbH.), solution of polyaminoamide polycarboxylate, amine value 37 mgKOH/g, acid value 41 mgKOH/g, solubility in solvent S-1 300 g/L, solubility in solvent S-2 300 g/L

D-6: trade name “TARREN VA-705B” (manufactured by KYOEISHA CHEMICAL CO., LTD.), higher fatty acid amide, solubility in solvent S-1 100 g/L, solubility in solvent S-2 100 g/L.

D-7: trade name “FLOWNON RCM-300TL” (manufactured by KYOEISHA CHEMICAL CO., LTD.), higher fatty acid amide, solubility in solvent S-1 100 g/L, solubility in solvent S-2 100 g/L

D-8: the following compound

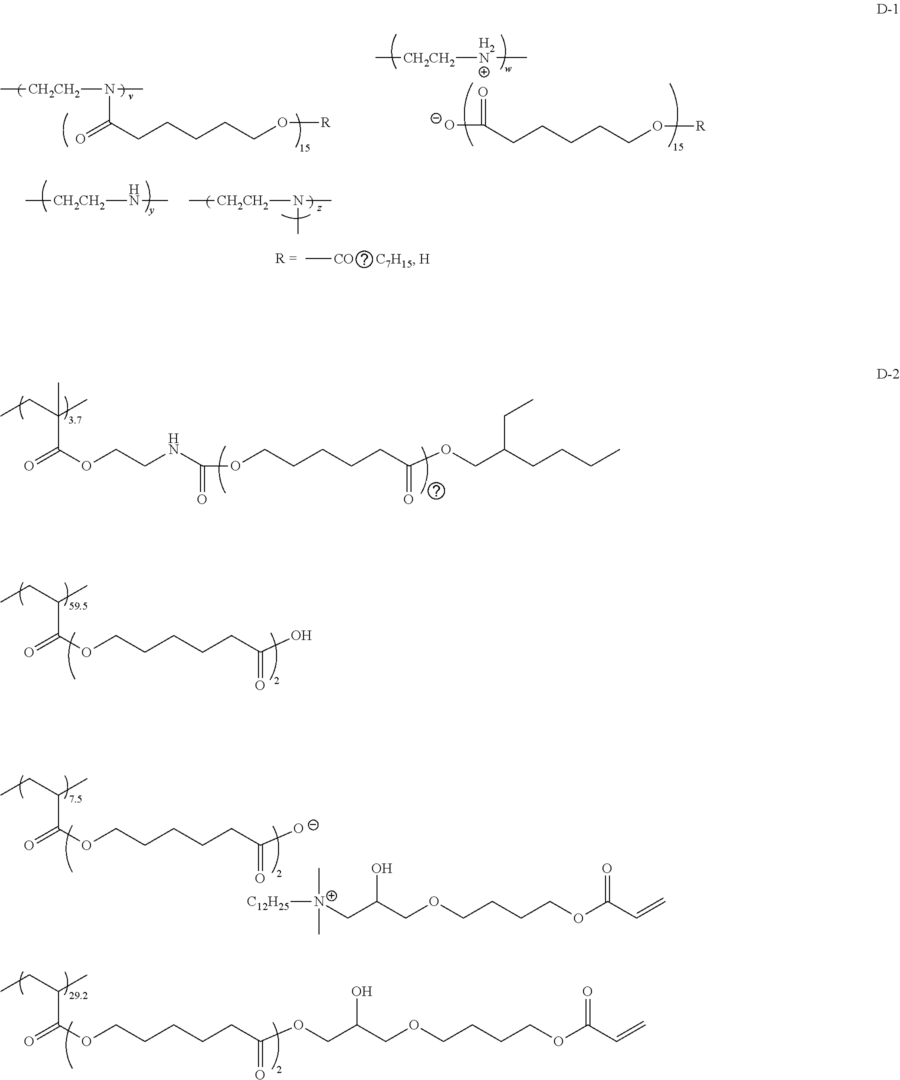

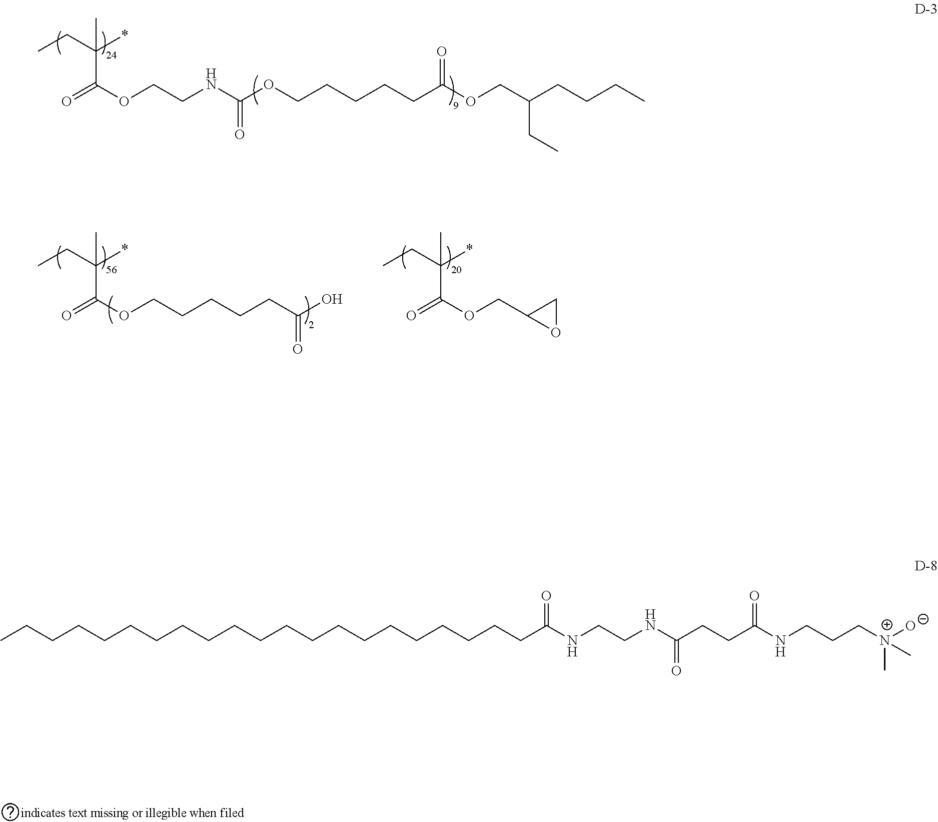

### [Solvent]

S-1: propylene glycol monomethyl ether acetate (PGMEA), boiling point 146° C. S-2: 1,4-butanediol diacetate (1,4-BDDA), boiling point 232° C.

### [Other Components]

A-1: Curing accelerator (triphenylphosphine, manufactured by TOKYO CHEMICAL INDUSTRY CO., LTD.)

A-2: photopolymerization initiator (trade name “IRGACURE-OXE03”, manufactured by BASF SE)

A-3: polymerizable compound (trade name “KAYARAD RP-1040”, manufactured by Nippon Kayaku Co., Ltd., polyfunctional acrylic monomer)

A-4: polymerizable compound (trade name “CELLOXIDE 2021P”, manufactured by DAICEL CORPORATION., polyfunctional epoxy monomer)

A-5: polymerizable compound (trade name “DENACOL EX-614”, manufactured by Nagase ChemteX Corporation., polyfunctional epoxy monomer)

A-6: photopolymerization initiator (trade name “ADEKA ARKLS NCI-831”, manufactured by ADEKA CORPORATION)

A-7: polymerizable compound (trade name “A-TMMT”, manufactured by TOAGOSEI CO., LTD., polyfunctional acrylic monomer)

### [Preparation of Magnetic Particle-Containing Compositions of Examples and Comparative Examples]

The components shown in Table 1 except for solvents were mixed together so that the compositional ratio (based on mass) shown in Table 1 was achieved, and the mixture was put in an airtight container made of polytetrafluoroethylene (PTFE). Thereafter, solvents were added thereto so that the compositional ratio (based on mass) shown in Table 1 was achieved, and the container was then sealed, followed by dispersion for 2 hours at 50 G by using RAM (low-frequency resonance acoustic mixer) manufactured by Resodyn Acoustic Mixers, Inc., thereby preparing magnetic particle-containing compositions of examples and comparative examples.

### <Physical Properties of Magnetic Particle-Containing Composition>

For each of the magnetic particle-containing compositions, a particle size distribution curve showing a volume-based frequency distribution is obtained according to the method described above, and Dmax (μm), Dmin (μm), and Dmax/Dmin of magnetic particles contained in each of the magnetic particle-containing compositions were determined. The results are shown in Table 1.

For each of the magnetic particle-containing compositions, the viscosity at 23° C. was measured according to the method described above. Based on the value of viscosity measured, the viscosity was classified according to the following standard. The results are shown in Table 1.
(Rate raising condition: 0.1 (1/s))
A: 50 Pa·s or more
B: 1 Pa·s or more and less than 50 Pa·s
C: less than 1 Pa·s
(Rate raising condition: 1,000 (1/s))
A: Less than 10 Pa·s
B: 10 Pa·s or more and less than 50 Pa·s
C: 50 Pa·s or more

### [Manufacturing of Magnetic Particle-Containing Film for Magnetic Permeability Evaluation]

By using magnetic particle-containing compositions obtained as above, magnetic particle-containing films for magnetic permeability evaluation that will be described later were manufactured.

Specifically, each of the magnetic particle-containing compositions was dripped onto a silicon wafer (film thickness 100 μm) (hereinafter, this wafer will be also called “substrate A”), and then the substrate A was coated with the composition by using a Baker applicator so that a film having a thickness of 100 μm was obtained after baking which will be described later. Thereafter, the substrate A was baked for drying for 10 minutes by using a hot plate at 100° C. and then baked for curing for 15 minutes by using a hot plate at 230° C., thereby obtaining a magnetic particle-containing film for magnetic permeability evaluation.

In a case where a magnetic particle-containing composition contained a photopolymerization initiator, instead of baking for curing, exposure was performed on the entire surface of the coating film by using an ultraviolet (UV) cure device (manufactured by Ushio Inc.) at an exposure amount of 20 J/cm², thereby obtaining a magnetic particle-containing film for magnetic permeability evaluation.

### [Manufacturing of Magnetic Particle-Containing Film for Pattern Shape Evaluation]

Among the magnetic particle-containing compositions obtained as above, magnetic particle-containing compositions containing a photopolymerization initiator were used to manufacture a magnetic particle-containing film for pattern shape evaluation that will be described later.

Specifically, each of the above magnetic particle-containing compositions was dripped onto a silicon wafer (film thickness 700 μm) with an undercoat layer (manufactured by FUJIFILM Electronic Materials Co., Ltd., CT-4000L, thickness 0.1 μm) (hereinafter, this silicon wafer will be also called “substrate B”), and then the substrate B was coated with the composition by using a Baker applicator so that a film having a thickness of 30 μm was obtained after baking that will be described later. Subsequently, the substrate B was baked for drying for 10 minutes by using a hot plate at 100° C., thereby obtaining a dry film.

Then, through a mask having a line-and-space pattern (line width 300 μm, space width 300 μm), an exposure treatment was performed on the dry film by using a proximity exposure machine under the condition of 100 mJ/cm².

After the exposure, a shower development treatment was performed at 23° C. for 60 seconds by using a simple development device (manufactured by Mikasa Corporation.). As a developer, an aqueous solution with a tetramethylammonium hydroxide (TMAH) content of 0.3% by mass was used.

After the development, a rinsing treatment was performed by a spin shower using pure water, spin drying was then performed, and then a heating treatment (post-baking) was performed for 5 minutes by using a hot plate at 200° C.

In this way, a magnetic particle-containing film for pattern shape evaluation was obtained.

### [Evaluation Test]

### [Sedimentation Stability (Temporal Stability)]

A sample bottle made of glass (cylindrical bottle having a diameter of 23 mm and a height of 35 mm) was filled with 3 mL of the magnetic particle-containing composition obtained as above, sealed, and then left to stand at 25° C. for 30 days.

Thereafter, the magnetic particle-containing composition in the sample bottle was visually observed, and a distance d1 between the gas-liquid interface and the interface between a transparent region and an opaque region and a distance d2 between the gas-liquid interface and the bottom surface of the sample bottle were measured. By using the distance dl and the distance d2, the sedimentation stability was evaluated based on the following standard. In a case where a sample is graded 2 based on the following standard, the sample was evaluated as having excellent sedimentation stability. The results are shown in Table 1.
3: d1/d2=0
2: 0.4≥d1/d2>0
1: d1/d2>0.4

### [Magnetic Permeability]

The magnetic particle-containing film for magnetic permeability evaluation obtained as above was cut in a size of 10 mm×28 mm. For the cut sample, by using a high-frequency magnetic permeability measuring device (manufactured by KEYCOM Corp., Model No. PER01), a relative magnetic permeability μ′ at 100 MHz was measured and evaluated based on the following evaluation standard. In a case where a sample graded “3” based on the following evaluation standard, the sample was evaluated as having excellent magnetic permeability. The results are shown in Table 1.
5: The relative magnetic permeability μ′ is 20 or more.
4: The relative magnetic permeability μ′ is 15 or more and less than 20.
3: The relative magnetic permeability μ′ is 10 or more and less than 15.
2: The relative magnetic permeability μ′ is 5 or more and less than 10.
1: The relative magnetic permeability μ′ is 1 or more and less than 5.

### [Pattern Shape]

The magnetic particle-containing film for pattern shape evaluation obtained as above was observed using an optical microscope (trade name “BX53M”, manufactured by Olympus Corporation), and the pattern shape was evaluated based on the following evaluation standard. The results are shown in Table 1.
3: The line pattern is closely attached to the substrate, spaces are also formed, and there is no residue having a size of 50 μm or more.
2: The line pattern is closely attached to the substrate and spaces are formed, but a there is a residue having a size of 50 μm or more in the space portion.
1: The line pattern is not closely attached to the substrate or spaces are filled (there is no space).

TABLE 1

| | Makeup of magnetic particle-containing composition | | | | | | | | | | | | | | | | |
|---|---|---|---|---|---|---|---|---|---|---|---|---|---|---|---|---|---|
| | Magnetic particles | | Resin (dispersant) | | Other components | | Solvent | | | | | | Viscosity (23° C.) | | Evaluation result | | |
| | | Parts by | | Parts by | | Parts by | | Parts by | Dmax | Dmin | | | Shear rate | Shear rate | Magnetic | Temporal | Pattern |
| | Type | mass | Type | mass | Type | mass | Type | mass | (μm) | (μm) | Dmax/Dmin | Number of peak tops | 0.1 (1/s) | 1,000 (1/s) | permeability | stability | shape |
| Example 1 | M-1 | 42 | D-1 | 5 | A-4 | 5 | S-1 | 6 | 38 | 2.5 | 15.2 | 2 | B | A | 4 | 2 | — |
| | M-5 | 42 | | | | | | | | | | | | | | | |
| Example 2 | M-2 | 42 | D-1 | 5 | A-4 | 5 | S-1 | 6 | 38 | 4 | 9.5 | 2 | B | A | 4 | 2 | — |
| | M-5 | 42 | | | | | | | | | | | | | | | |
| Example 3 | M-3 | 42 | D-1 | 5 | A-4 | 5 | S-1 | 6 | 38 | 2 | 19 | 2 | B | A | 4 | 2 | — |
| | M-5 | 42 | | | | | | | | | | | | | | | |
| Example 4 | M-4 | 42 | D-1 | 5 | A-4 | 5 | S-1 | 6 | 38 | 4 | 9.5 | 2 | B | A | 4 | 2 | — |
| | M-5 | 42 | | | | | | | | | | | | | | | |
| Example 5 | M-1 | 42 | D-1 | 5 | A-4 | 5 | S-1 | 6 | 53 | 2.5 | 21.2 | 2 | B | A | 5 | 2 | — |
| | M-6 | 42 | | | | | | | | | | | | | | | |
| Example 6 | M-1 | 42 | D-1 | 5 | A-4 | 5 | S-1 | 6 | 150 | 2.5 | 60 | 2 | B | A | 3 | 2 | — |
| | M-7 | 42 | | | | | | | | | | | | | | | |
| Example 7 | M-1 | 42 | D-1 | 5 | A-4 | 5 | S-1 | 6 | 25 | 2.5 | 10 | 2 | B | A | 4 | 2 | — |
| | M-8 | 42 | | | | | | | | | | | | | | | |
| Example 8 | M-9 | 42 | D-1 | 5 | A-4 | 5 | S-1 | 6 | 38 | 5 | 7.6 | 2 | B | A | 4 | 2 | — |
| | M-5 | 42 | | | | | | | | | | | | | | | |
| Example 9 | M-1 | 42 | D-1 | 5 | A-4 | 5 | S-1 | 6 | 13 | 2.5 | 5.2 | 2 | B | A | 4 | 2 | — |
| | M-10 | 42 | | | | | | | | | | | | | | | |
| Example 10 | M-1 | 42 | D-1 | 5 | A-4 | 5 | S-1 | 6 | 7 | 2.5 | 2.8 | 2 | B | A | 3 | 2 | — |
| | M-11 | 42 | | | | | | | | | | | | | | | |
| Example 11 | M-11 | 42 | D-1 | 5 | A-4 | 5 | S-1 | 6 | 53 | 15 | 3.5 | 2 | B | A | 4 | 2 | — |
| | M-6 | 42 | | | | | | | | | | | | | | | |
| Example 12 | M-12 | 42 | D-1 | 5 | A-4 | 5 | S-1 | 6 | 38 | 5 | 7.6 | 2 | B | A | 4 | 2 | — |
| | M-5 | 42 | | | | | | | | | | | | | | | |
| Example 13 | M-13 | 42 | D-1 | 5 | A-4 | 5 | S-1 | 6 | 38 | 4 | 9.5 | 2 | B | A | 4 | 2 | — |
| | M-5 | 42 | | | | | | | | | | | | | | | |
| Example 14 | M-1 | 42 | D-1 | 5 | A-4 | 5 | S-1 | 6 | 8 | 2.5 | 3.2 | 2 | B | A | 4 | 2 | — |
| | M-14 | 42 | | | | | | | | | | | | | | | |
| Example 15 | M-15 | 42 | D-1 | 5 | A-4 | 5 | S-1 | 6 | 38 | 2.5 | 15.2 | 2 | B | A | 4 | 2 | — |
| | M-5 | 42 | | | | | | | | | | | | | | | |
| Example 16 | M-16 | 42 | D-1 | 5 | A-4 | 5 | S-1 | 6 | 5 | 0.1 | 50 | 2 | B | A | 3 | 2 | — |
| | M-17 | 42 | | | | | | | | | | | | | | | |
| Example 17 | M-17 | 42 | D-1 | 5 | A-4 | 5 | S-1 | 6 | 15 | 5 | 3 | 2 | B | A | 3 | 2 | — |
| | M-18 | 42 | | | | | | | | | | | | | | | |
| Example 18 | M-16 | 42 | D-1 | 5 | A-4 | 5 | S-1 | 6 | 15 | 0.1 | 150 | 2 | B | A | 3 | 2 | — |
| | M-18 | 42 | | | | | | | | | | | | | | | |
| Example 19 | M-3 | 40 | D-2 | 5 | A-2 | 5 | S-1 | 5 | 38 | 2 | 19 | 2 | B | A | 3 | 2 | 3 |
| | M-5 | 40 | | | A-3 | 5 | | | | | | | | | | | |
| Example 20 | M-3 | 45 | D-3 | 5 | | | S-1 | 5 | 38 | 2 | 19 | 2 | B | A | 5 | 2 | — |
| | M-5 | 45 | | | | | | | | | | | | | | | |
| Example 21 | M-3 | 40 | D-4 | 10 | A-4 | 5 | S-1 | 5 | 38 | 2 | 19 | 2 | A | A | 3 | 3 | — |
| | M-5 | 40 | | | | | | | | | | | | | | | |
| Example 22 | M-3 | 44 | D-5 | 2 | A-4 | 5 | S-1 | 5 | 38 | 2 | 19 | 2 | A | A | 5 | 3 | — |
| | M-5 | 44 | | | | | | | | | | | | | | | |
| Example 23 | M-3 | 36 | D-6 | 3 | A-4 | 5 | S-1 | 20 | 38 | 2 | 19 | 2 | A | A | 5 | 3 | — |
| | M-5 | 36 | | | | | | | | | | | | | | | |
| Example 24 | M-3 | 36 | D-7 | 3 | A-4 | 5 | S-1 | 20 | 38 | 2 | 19 | 2 | A | A | 5 | 3 | — |
| | M-5 | 36 | | | | | | | | | | | | | | | |
| Example 25 | M-1 | 24 | D-6 | 3 | A-4 | 5 | S-1 | 20 | 53 | 2.5 | 21.2 | 3 | A | A | 5 | 3 | — |
| | M-11 | 24 | | | | | | | | | | | | | | | |
| | M-6 | 24 | | | | | | | | | | | | | | | |
| Example 26 | M-15 | 24 | D-6 | 3 | A-4 | 5 | S-1 | 20 | 15 | 0.1 | 150 | 3 | A | A | 3 | 3 | — |
| | M-11 | 24 | | | | | | | | | | | | | | | |
| | M-16 | 24 | | | | | | | | | | | | | | | |
| Example 27 | M-1 | 18 | D-6 | 3 | A-4 | 5 | S-1 | 20 | 53 | 2.5 | 21.2 | 3 | A | A | 5 | 3 | — |
| | M-11 | 18 | | | | | | | | | | | | | | | |
| | M-6 | 36 | | | | | | | | | | | | | | | |
| Example 28 | M-1 | 18 | D-6 | 3 | A-4 | 5 | S-1 | 20 | 53 | 2.5 | 21.2 | 3 | A | A | 5 | 3 | — |
| | M-11 | 36 | | | | | | | | | | | | | | | |
| | M-6 | 18 | | | | | | | | | | | | | | | |
| Example 29 | M-1 | 36 | D-6 | 3 | A-4 | 5 | S-1 | 20 | 53 | 2.5 | 21.2 | 3 | A | A | 5 | 3 | — |
| | M-11 | 18 | | | | | | | | | | | | | | | |
| | M-6 | 18 | | | | | | | | | | | | | | | |
| Example 30 | M-1 | 12 | D-6 | 3 | A-4 | 5 | S-1 | 20 | 53 | 2.5 | 21.2 | 3 | B | A | 5 | 2 | — |
| | M-11 | 12 | | | | | | | | | | | | | | | |
| | M-6 | 48 | | | | | | | | | | | | | | | |
| Example 31 | M-1 | 12 | D-6 | 3 | A-4 | 5 | S-1 | 20 | 53 | 2.5 | 21.2 | 3 | A | A | 5 | 3 | — |
| | M-11 | 48 | | | | | | | | | | | | | | | |
| | M-6 | 12 | | | | | | | | | | | | | | | |
| Example 32 | M-1 | 48 | D-6 | 3 | A-4 | 5 | S-1 | 20 | 53 | 2.5 | 21.2 | 3 | A | A | 4 | 3 | — |
| | M-11 | 12 | | | | | | | | | | | | | | | |
| | M-6 | 12 | | | | | | | | | | | | | | | |
| Example 33 | M-16 | 24 | D-6 | 3 | A-4 | 5 | S-1 | 20 | 15 | 0.1 | 150 | 3 | A | A | 3 | 2 | — |
| | M-17 | 24 | | | | | | | | | | | | | | | |
| | M-18 | 24 | | | | | | | | | | | | | | | |
| Example 34 | M-3 | 36 | D-6 | 3 | A-4 | 5 | S-1 | 20 | 38 | 2 | 19 | 2 | B | A | 5 | 3 | — |
| | M-5 | 36 | | | | | | | | | | | | | | | |
| Example 35 | M-3 | 12 | D-6 | 3 | A-4 | 5 | S-1 | 20 | 38 | 2 | 19 | 2 | A | A | 5 | 2 | — |
| | M-5 | 60 | | | | | | | | | | | | | | | |
| Example 36 | M-3 | 24 | D-6 | 3 | A-4 | 5 | S-1 | 20 | 38 | 2 | 19 | 2 | A | A | 5 | 3 | — |
| | M-5 | 48 | | | | | | | | | | | | | | | |
| Example 37 | M-3 | 48 | D-6 | 3 | A-4 | 5 | S-1 | 20 | 38 | 2 | 19 | 2 | A | A | 5 | 3 | — |
| | M-5 | 24 | | | | | | | | | | | | | | | |
| Example 38 | M-3 | 60 | D-6 | 3 | A-4 | 5 | S-1 | 20 | 38 | 2 | 19 | 2 | A | A | 4 | 3 | — |
| | M-5 | 12 | | | | | | | | | | | | | | | |
| Example 39 | M-3 | 34 | D-1 | 2 | A-4 | 5 | S-1 | 20 | 38 | 2 | 19 | 2 | A | A | 4 | 3 | — |
| | M-5 | 35 | D-6 | 4 | | | | | | | | | | | | | |
| Example 40 | M-3 | 37 | D-1 | 4 | A-4 | 5 | S-1 | 15 | 38 | 2 | 19 | 2 | A | A | 4 | 2 | — |
| | M-5 | 37 | D-6 | 2 | | | | | | | | | | | | | |
| Example 41 | M-3 | 41 | D-4 | 1 | A-4 | 5 | S-1 | 10 | 38 | 2 | 19 | 2 | A | A | 5 | 3 | — |
| | M-5 | 41 | D-6 | 2 | | | | | | | | | | | | | |
| Example 42 | M-3 | 42 | D-1 | 5 | A-5 | 5 | S-1 | 6 | 38 | 2 | 19 | 2 | B | A | 4 | 2 | — |
| | M-5 | 42 | | | | | | | | | | | | | | | |
| Example 43 | M-3 | 42 | D-1 | 5 | A-4 | 1 | S-1 | 6 | 38 | 2 | 19 | 2 | B | A | 4 | 2 | — |
| | M-5 | 42 | | | A-5 | 4 | | | | | | | | | | | |
| Example 44 | M-3 | 42 | D-1 | 5 | A-4 | 2.5 | S-1 | 6 | 38 | 2 | 19 | 2 | B | A | 4 | 2 | — |
| | M-5 | 42 | | | A-5 | 2.5 | | | | | | | | | | | |
| Example 45 | M-3 | 42 | D-1 | 5 | A-4 | 4 | S-1 | 6 | 38 | 2 | 19 | 2 | B | A | 4 | 2 | — |
| | M-5 | 42 | | | A-5 | 1 | | | | | | | | | | | |
| Example 46 | M-3 | 42 | D-1 | 5 | A-4 | 3 | S-1 | 6 | 38 | 2 | 19 | 2 | B | A | 4 | 2 | — |
| | M-5 | 42 | | | | | | | | | | | | | | | |
| Example 47 | M-3 | 42 | D-1 | 5 | A-4 | 10 | S-1 | 6 | 38 | 2 | 19 | 2 | B | A | 3 | 2 | — |
| | M-5 | 42 | | | | | | | | | | | | | | | |
| Example 48 | M-3 | 35 | D-6 | 3 | A-4 | 5 | S-1 | 20 | 38 | 2 | 19 | 2 | A | A | 5 | 3 | — |
| | M-5 | 36 | | | A-1 | 1 | | | | | | | | | | | |
| Example 49 | M-3 | 35 | D-6 | 3 | A-4 | 5 | S-1 | 20 | 38 | 2 | 19 | 2 | A | A | 5 | 3 | — |
| | M-5 | 34 | | | A-1 | 3 | | | | | | | | | | | |
| Example 50 | M-3 | 41 | D-6 | 3 | A-4 | 5 | S-1 | 10 | 38 | 2 | 19 | 2 | A | A | 5 | 3 | — |
| | M-5 | 41 | | | | | | | | | | | | | | | |
| Example 51 | M-3 | 31 | D-6 | 3 | A-4 | 5 | S-1 | 30 | 38 | 2 | 19 | 2 | A | A | 5 | 3 | — |
| | M-5 | 31 | | | | | | | | | | | | | | | |
| Example 52 | M-3 | 26 | D-6 | 3 | A-4 | 5 | S-1 | 40 | 38 | 2 | 19 | 2 | B | A | 5 | 2 | — |
| | M-5 | 26 | | | | | | | | | | | | | | | |
| Example 53 | M-3 | 41 | D-6 | 3 | A-4 | 5 | S-1 | 10 | 38 | 2 | 19 | 2 | A | A | 5 | 3 | — |
| | M-5 | 41 | | | | | | | | | | | | | | | |
| Example 54 | M-3 | 30 | D-6 | 6 | A-4 | 5 | S-1 | 30 | 38 | 2 | 19 | 2 | A | A | 4 | 3 | — |
| | M-5 | 29 | | | | | | | | | | | | | | | |
| Example 55 | M-3 | 23 | D-6 | 9 | A-4 | 5 | S-1 | 40 | 38 | 2 | 19 | 2 | B | A | 3 | 3 | — |
| | M-5 | 23 | | | | | | | | | | | | | | | |
| Example 56 | M-3 | 36 | D-6 | 3 | A-4 | 5 | S-2 | 20 | 38 | 2 | 19 | 2 | A | A | 5 | 3 | — |
| | M-5 | 36 | | | | | | | | | | | | | | | |
| Example 57 | M-3 | 36 | D-6 | 3 | A-4 | 5 | S-1 | 10 | 38 | 2 | 19 | 2 | A | A | 5 | 3 | — |
| | M-5 | 36 | | | | | S-2 | 10 | | | | | | | | | |
| Example 58 | M-3 | 36 | D-6 | 3 | A-4 | 5 | S-1 | 5 | 38 | 2 | 19 | 2 | A | A | 5 | 3 | — |
| | M-5 | 36 | | | | | S-2 | 15 | | | | | | | | | |
| Example 59 | M-3 | 36 | D-6 | 3 | A-4 | 5 | S-1 | 15 | 38 | 2 | 19 | 2 | A | A | 5 | 3 | — |
| | M-5 | 36 | | | | | S-2 | 5 | | | | | | | | | |
| Example 60 | M-3 | 36 | D-5 | 3 | A-2 | 5 | S-1 | 20 | 38 | 2 | 19 | 2 | A | A | 3 | 3 | 2 |
| | M-5 | 36 | | | A-3 | 5 | | | | | | | | | | | |
| Example 61 | M-3 | 40 | D-2 | 5 | A-2 | 5 | S-1 | 5 | 38 | 2 | 19 | 2 | B | A | 3 | 2 | 3 |
| | M-5 | 40 | | | A-3 | 5 | | | | | | | | | | | |
| Example 62 | M-3 | 40 | D-2 | 5 | A-2 | 5 | S-1 | 5 | 38 | 2 | 19 | 2 | B | A | 3 | 2 | 3 |
| | M-5 | 40 | | | A-6 | 5 | | | | | | | | | | | |
| Example 63 | M-3 | 40 | D-2 | 5 | A-2 | 5 | S-1 | 5 | 38 | 2 | 19 | 2 | B | A | 3 | 2 | 3 |
| | M-5 | 40 | | | A-3 | 2.5 | | | | | | | | | | | |
| | | | | | A-6 | 2.5 | | | | | | | | | | | |
| Example 64 | M-3 | 40 | D-2 | 5 | A-2 | 2.5 | S-1 | 5 | 38 | 2 | 19 | 2 | B | A | 3 | 2 | 3 |
| | M-5 | 40 | | | A-7 | 2.5 | | | | | | | | | | | |
| | | | | | A-3 | 5 | | | | | | | | | | | |
| Example 65 | M-1 | 18 | D-6 | 3 | A-4 | 5 | S-1 | 20 | 150 | 2.5 | 60 | 4 | A | A | 5 | 3 | — |
| | M-11 | 18 | | | | | | | | | | | | | | | |
| | M-6 | 18 | | | | | | | | | | | | | | | |
| | M-7 | 18 | | | | | | | | | | | | | | | |
| Example 66 | M-3 | 36 | D-8 | 3 | A-4 | 5 | S-1 | 20 | 38 | 2 | 19 | 2 | A | A | 5 | 3 | — |
| | M-5 | 36 | | | | | | | | | | | | | | | |
| Comparative | M-3 | 84 | D-1 | 5 | A-4 | 5 | S-1 | 6 | — | — | — | 1 | C | A | 2 | 3 | — |
| Example 1 | | | | | | | | | | | | | | | | | |
| Comparative | M-5 | 84 | D-1 | 5 | A-4 | 5 | S-1 | 6 | — | — | — | 1 | C | A | 4 | 1 | — |
| Example 2 | | | | | | | | | | | | | | | | | |

As shown in Table 1, the magnetic particle-containing composition that contained magnetic particles having a plurality of peak tops in a particle size distribution curve showing a volume-based frequency distribution, a resin, and a solvent was excellent in sedimentation stability, and a magnetic particle-containing film formed of this composition had excellent magnetic permeability (examples).

The comparison of Examples 1 to 12 has revealed that in a case where Dmax/Dmin is more than 2 (Examples 1 to 9, 11, and 12), the magnetic particle-containing film formed of such a composition has higher magnetic permeability.

The comparison between Example 3 and Examples 21 to 24 has revealed that in a case where a resin having an acid group, a basic group, or an amide group is used (Examples 21 to 24), the sedimentation stability of the magnetic particle-containing composition is further improved.

The comparison of Examples 50 to 55 has revealed that in a case where the content of the magnetic particles is 60% by mass or more with respect to the total mass of the magnetic particle-containing composition (Examples 50, 51, and 53), higher sedimentation stability of the magnetic particle-containing composition and higher magnetic permeability of the magnetic particle-containing film can be simultaneously achieved.

On the other hand, it has been revealed that in a case where the magnetic particles contained in the magnetic particle-containing composition has one peak top in a particle size distribution curve showing a volume-based frequency distribution, at least either the sedimentation stability of the magnetic particle-containing composition or the magnetic permeability of the magnetic particle-containing film formed of the composition deteriorates (comparative examples).

What is claimed is:

1. A magnetic particle-containing composition comprising:
magnetic particles having a plurality of peak tops in a particle size distribution curve showing a volume-based frequency distribution;
a resin; and
a solvent.

2. The magnetic particle-containing composition according to claim 1,
wherein in a case where Dmin represents a particle diameter at a peak top Pmin where a particle diameter is minimized and Dmax represents a particle diameter at a peak top Pmax where a particle diameter is maximized among the plurality of peak tops in the particle size distribution curve showing a volume-based frequency distribution, a ratio of the Dmax to the Dmin is more than 2.

3. The magnetic particle-containing composition according to claim 1,
wherein in a case where Dmin represents a particle diameter at a peak top Pmin where a particle diameter is minimized among the plurality of peak tops in the particle size distribution curve showing a volume-based frequency distribution, the Dmin is equal to or greater than a particle diameter D₂₀ having a frequency of 20% in the particle size distribution curve showing a volume-based cumulative distribution.

4. The magnetic particle-containing composition according to claim 2,
wherein the Dmin is 1 to 10 μm.

5. The magnetic particle-containing composition according to claim 1,
wherein the magnetic particles have two peak tops.

6. The magnetic particle-containing composition according to claim 1,
wherein a content of the magnetic particles is 60% by mass or more with respect to a total mass of the magnetic particle-containing composition.

7. The magnetic particle-containing composition according to claim 1,
wherein the resin has an acid group, a basic group, or an amide group.

8. The magnetic particle-containing composition according to claim 1,
wherein a solubility of the resin in the solvent is 10 g/L or more.

9. A magnetic particle-containing film formed of the magnetic particle-containing composition according to claim 1.

10. An electronic component comprising:
the magnetic particle-containing film according to claim 9.

11. The electronic component according to claim 10,
wherein the electronic component is used as an inductor.

12. The electronic component according to claim 10,
wherein the electronic component is used as an antenna.
